(19) United States
(12) Patent Application Publication
(10) Pub. No.: US 2007/0079282 A1
(43) Pub. Date: Apr. 5, 2007

(54) Browser based designer and player

(76) Inventors: Pawan Nachnani, Newark, CA (US); Jin Huang, Mountain House, CA (US); Ramesh Kagoo, Pleasanton, CA (US); Sampath Thasampalayam, Fremont, CA (US); Lawrence Lindsey, Livermore, CA (US); Paul M. Tabet, Danville, CA (US)

Correspondence Address: MORRISON & FOERSTER LLP, 755 PAGE MILL RD, PALO ALTO, CA, 94304-1018, US

(21) Appl. No.: 11/241,073

(22) Filed: Sep. 30, 2005

(51) Int. Cl. G06F 9/44

(52) U.S. Cl. 717/106

(57) ABSTRACT

A system for designing, deploying, and executing enterprise applications is provided. The system allows for rapid development and deployment of Web-based data-oriented applications. Multiple versions of the applications can exist simultaneously without conflicts. The applications may be web services enabled and process driven.

### BACKGROUND OF THE INVENTION

1. Field of the Invention

The present invention relates generally to methods for programming a machine to perform data processing, and in one aspect to methods for programming a machine to perform specific data processing tasks described in a simplified manner.

2. Description of the Related Art

Today, most types of software applications are installed directly on a user's computer. Examples of such applications include the Microsoft™ Word™, Adobe™ Photoshop™, and Intuit™ Quicken™ computer programs. A user of such an application generally is limited to using that application on the computers on which it has been installed. This limitation is problematic if a user is traveling and does not have physical access to the computer on which an application is installed. Furthermore, updating these applications to add new features or fix defects requires installation of updates directly on the user's computer, which is often a time-consuming process.

Web applications, also referred to herein as browser-based applications, solve such usability and installation problems by using a web browser, e.g. Microsoft Internet Explorer™ or Mozilla Firefox™, and a web server, e.g. Apache™ or Microsoft™ Internet Information Services™. An application can be divided into at least two main parts: a user interface, which is presented to a user and interacts with the user, and business logic, which performs the tasks required of the application, in accordance with user input received from the user interface. The web browser runs the user interface. The web server provides the user interface to the web browser and runs the business logic, possibly in cooperation with other servers such as an application server, e.g. JBoss™ or BEA™ WebLogic™, and a database server, e.g. Oracle™. The web application need not be installed directly on the user's computer. The term server or web server here refers to software executed on a computer, also referred to generally in the field as a server platform.

A web browser is a type of specialized software application, typically installed directly on the user's computer, which allows a user to view and interact with web pages. Web pages are documents, typically in HyperText Markup Language (HTML) format that the web browser retrieves from a web server computer via a network, using a protocol such as the HyperText Transfer Protocol (HTTP). Web pages may include software code in a programming language such as JavaScript™ which will be executed by the web browser when the page is retrieved. A web application includes a user-interface component that is loaded as part of a web page by a browser via a network connection. A web application's user interface may be implemented as a web page using HTML and JavaScript™. A browser-equipped computer, therefore, uses a network connection to permit a user to access a web application running on a remote server, for example. Furthermore, web applications can be updated at any time by installing the update on the server.

Computer software applications are often required to perform operations that are specific to a particular user or organization. For example, a software application may be used to in a hospital to request clinical tests. The software application may include a set of data fields for which a user provides data values, such as a patient name and a test name. A particular hospital may also require a patient medical record number in a format defined by that hospital. In general, the set of data fields, and actions to be taken after data values have been provided, are dependent on the needs of the hospital, and may change over time. Therefore there is a need for customization of software to meet specific requirements. Customization of software may include developing new software or modifying existing software. Customization can be done by a programmer using a programming language such as C++, Java, or BASIC. However, the use of such languages often requires substantial time and effort, as well as specialized knowledge of the programming language, so such customization by programming can be expensive. Rapid Application Development (RAD) tools address these problems by simplifying programming tasks. A typical RAD tool is software that includes a graphical user interface for laying out application user interfaces and defining application behaviors in terms of predefined actions such as data entry and database access. A RAD tool may present a list of predefined behaviors or actions from which a user can choose when creating or extending an application. RAD tools are generally easier to learn and use than conventional programming-language based approaches for developing applications, and can shorten the time required to develop applications. Existing RAD tools include Borland Delphi™, Microsoft Visual Basic™, and Macromedia/Adobe ColdFusion™, which can be used to develop a wide range of applications, but often require some programming. RAD tools such as Intuit QuickBase and Microsoft InfoPath can be used to develop applications that involve filling out data forms and accessing databases.

There is a need for non-programmers to design, develop, and deploy simple to complex, composite and monolithic applications in the business world today. Application development is a costly, time consuming, and risky proposition for even capable engineering organizations, let alone business analysts and other non-technical staff. Few organizations have the resources to use complex development tools and deployment environments to build and deploy applications. This engineering capability void has fostered a large and thriving software industry as known today. Even so, packaged software applications are expensive to purchase and even more expensive to install, configure and maintain. A new breed of Software As A Service, (SAAS,) vendors have evolved to deliver complex software as a service to further eliminate complexity and reduce costs to leverage software application benefits. Even with SAAS vendors providing robust pre-built applications, only a small percentage of business software application requirements are met and hence, the need for both applications and infrastructure that is aimed at business analysts and programmers to design, develop and deploy applications quickly and efficiently.

Several of the RAD tools described above provide support for creating web applications. Delphi™, Visual Basic™, and ColdFusion™ simplify the development of web applications created using programming languages. That is, those tools simplify the creation of user interfaces by providing graphical user interface builder tools that can be easily connected to business logic implemented in a programming language, but it is still necessary to write code in a programming language for some portions of the application, such as the business logic. QuickBase™ provides for rapid development of forms-based web applications using a graphical user interface. Furthermore, QuickBase itself is a web application, which means that it allows web applications to be developed using the same web application model in which the applications will be deployed. That is, users of QuickBase can develop applications on any computer running a web browser, without directly installing QuickBase software on their own computer. QuickBase applications may also be hosted on web servers provided by a software vendor, for example, Intuit, so that users are not required to provide a web server to host QuickBase applications they develop.

InfoPath™ from Microsoft™ provides for rapid development of forms. InfoPath forms can optionally be made available as web applications, but the InfoPath form designer itself is not a web application and must be installed directly on a user's computer. Furthermore, InfoPath depends on other Microsoft products such as Internet Explorer™ and does not work with browsers from other vendors, such as Mozilla Firefox™. Therefore InfoPath forms can only be accessed from computers on which InfoPath™ and related Microsoft™ products are installed.

Existing RAD tools do not combine the benefits of web applications with features such as customizable processing in a scripting language, linkage with external data sources such as databases, and linkage to web services. We have recognized that it would be desirable to have an easy-to-use RAD tool which is itself a web application, and which allows a user to quickly develop and customize web-based data processing applications that can include data input, validation, processing, and linkage with web services. Such a RAD tool could be used to quickly and efficiently develop and customize applications using any computer that has a standard web browser and access to the Internet. Furthermore, web applications typically require complex business logic for their activities. This logic is typically written in strongly typed languages and the logic requires recompilation and redeployment. It would be desirable to provide a RAD tool with a scripting language which can change or extend the behavior of web applications without the additional overhead of recompilation or redeployment.

Existing Web-based RAD tools do not provide a single unified interface and environment for building a web application that includes a user interface linked to persistent data stored in a database. Existing Web-based RAD tools disadvantageously use a multi-step process that starts at the level of individual data elements, and expect the user to perform a series of steps to define a user interface linked to persistent data. These steps typically include defining a field, defining an object, defining a container, linking the objects, defining a user interface, and linking the user interface to the objects and fields, all of which are complex and time-consuming.

### SUMMARY OF THE INVENTION

In general, in a first aspect, the invention features a computer enabled method of creating a software application. The method includes the acts of providing a user interface for designing the software application on a web browser, defining aspects of the application via the web browser using the user interface, and transmitting the defined aspects to a server over a computer network to create a web-based software application. Embodiments of the invention may include one or more of the following features. The method of creating a software application may include the acts of providing a set of components on the web browser and implementing aspects of the application using the components. The method may include the steps of providing a library on the browser and using the library as an intermediary between the defined aspects at the browser and the server. The computer network may include the Internet. The method may include, at the server, the steps of rendering a representation of the application from the transmitted defined aspects, retrieving data associated with the application from a storage, and transmitting the representation and retrieved data to a client. The method may include, at the client, the act of executing the representation and data on a web browser. The method may include the acts of providing a library on the web browser of the client and using the library as an intermediary between the web browser of the client and the server. The method may include the acts of tracking multiple versions of the software application, maintaining each version as compatible with prior versions of the software application, and allowing multiple of the versions to be active at the same time.

In a second aspect, the invention features a computer enabled method of providing a software application, including the acts of receiving at a server over a computer network from a first client web browser a software application including defined aspects of the application, rendering a representation of the application from the received defined aspects, retrieving data associated with the application from a storage, and transmitting the representation and retrieved data to a second client. Embodiments of the invention may include one or more of the following features. In the method of providing a software application, the computer network may include the Internet. The method of providing a software application may include, at the second client, the steps of providing a web browser and providing a user interface to a user on the web browser from the received representation and data. The method of providing a software application may include, at the second client, the acts of: providing a library on the browser and using the library as an intermediary between the browser and the server. The method of providing a software application may include the acts of providing a user interface on the web browser at the first client for designing the software application, defining the aspects of the application using the user interface, and transmitting the defined aspects to the server over the computer network. The method of providing a software application may include the acts of tracking a plurality of versions of the software application, maintaining each version as compatible with prior versions of the software application, and allowing a plurality of the versions to be active at the same time.

In general, in a third aspect, the invention features a computer enabled method of providing a software application, including the acts of receiving over a computer network aspects of an application from a server, executing the application on a web browser, providing a user interface, and allowing use of the application via the user interface.

In general, in a fourth aspect, the invention features a client to be executed on a computer. The client includes a user interface adapted for designing a software application on a web browser and an application definition module which defines aspects of the software application via the web browser using the user interface. Furthermore, the web browser may transmit the defined aspects to a server over a computer network to create the software application. Embodiments of the invention may include one or more of the following features. Multiple components may be on the web browser, and some of the aspects of the application may be implemented using the components. The client may include a library on the browser, and the library may be used as an intermediary between the defined aspects at the browser and the server. The computer network may include the Internet.

In general, in a fifth aspect, the invention features an application server to be executed on a computer. The application server includes an application definition module for receiving over a computer network from a first client web browser a software application, including defined aspects of the application, and rendering a representation of the application from the received defined aspects. The application server also includes a service for retrieving data associated with the application from a storage, and an application player module for transmitting the representation and retrieved data to a second client. The application server may include, at the server, a version control for tracking multiple versions of the software application, maintaining each version as compatible with prior versions of the software application, and allowing multiple versions to be active at the same time.

In general, in a sixth aspect, the invention features a player client to be executed on a computer. The player client includes a definition module for receiving over a computer network aspects of an application from a server, a data module for receiving over the computer network from the server data relating to the application, and a user interface for executing the application on a web browser. Embodiments of the invention may include one or more of the following features. The player client may use a library on the browser as an intermediary between defined aspects of the application and the server.

In general, in a seventh aspect, the invention features a method of running an application program in a web browser, including the acts of providing at least one client computer and one server computer in communication with the network, executing a web browser on the client computer, executing a client portion of the application program on the web browser, wherein the client portion presents a runtime user interface according to an application definition. The application definition includes a component described by a component definition, the component includes a name and a data value, and the client portion receives the data value from a user. The method of running an application program further includes the step of executing a server portion of the application program on the server computer, wherein the server portion receives the data value from the client portion and stores the data value in a database, as specified by the application definition. Embodiments of the invention may include one or more of the following features. The component may include a link, the link may refer to a web service, and the client program may receive the data value from the web service in response to a user action. The component may include a script operable to execute in response to an application event, and the script may perform calculations based on a data value associated with another component. The script may set a data value associated with another component. The component may be associated with a row of a table component.

In general, in an eighth aspect, the invention features a method for designing an application program in a web browser, including the acts of providing at least one client computer and one server computer in communication with the network, executing a web browser on the client computer, and executing a designer program on the web browser. The the designer program presents a user interface that includes a workspace upon which a user can place an interface component at a specified location, the interface component being associated with a component data value. The designer program creates an application definition, the application definition describing properties of the interface component, including an association between the component data value and a corresponding component data value in a database.

Embodiments of the invention may include one or more of the following features. The component may be associated with a link, and the designer program may receive a Uniform Resource Locator associated with the link from a user. The component may be associated with a computer program code script, the designer program may receive the computer program code script from a user, and the computer program code script may perform calculations based on the value of another component. The computer program code script may set the value of another component. The user may place a table component upon the workspace. The table component may include a table header row having at least one column definition and a table detail row having at least one column corresponding to the at least one column definition, and the column may be associated with a detail component having a detail data value. The application definition may describe the table component and an association between the at least one detail data value and a corresponding detail column in a database.

### BRIEF DESCRIPTION OF THE DRAWINGS

FIG. 1a is an illustrative drawing of an enterprise application design and deployment system according to one embodiment of the invention.

FIG. 1b is an illustrative drawing of a browser-based application according to one embodiment of the invention.

FIGS. 2a and 2b are illustrative drawings of application definitions according to one embodiment of the invention.

FIG. 3 is an illustrative drawing of an application user interface according to one embodiment of the invention.

FIGS. 4a and 4b are illustrative drawings an application definition format according to one embodiment of the invention.

FIGS. 5a, 5b, and 5c are illustrative drawings of application definitions according to one embodiment of the invention.

FIGS. 6a, 6b, and 6c are illustrative drawings of an application data format and application data values according to one embodiment of the invention.

FIGS. 7a-7i are illustrative drawings of an Application Designer and Application Player user interfaces, according to one embodiment of the invention.

FIG. 8 is an illustrative drawing of client and server components of an enterprise application design and deployment system according to one embodiment of the invention.

FIG. 9 is an illustrative drawing of a method of creating or updating an application according to one embodiment of the invention.

FIGS. 10a and 10b are illustrative drawings of flowcharts of a method of loading an existing application according to one embodiment of the invention.

FIG. 11 is an illustrative drawing of a method of saving application data according to one embodiment of the invention.

FIG. 12a is an illustrative drawing of an application including a mode and a version number according to one embodiment of the invention.

FIG. 12b is an illustrative drawing of application mode transitions according to one embedment of the invention.

FIG. 13 is an illustrative drawing of a database schema for storing an application definition according to one embedment of the invention.

FIG. 14 is an illustrative drawing of database schemas for storing application data according to one embedment of the invention.

### DETAILED DESCRIPTION OF A PREFERRED EMBODIMENT

The following description is presented to enable any person skilled in the art to make and use the invention, and is provided in the context of particular applications and their requirements. Various modifications to the preferred embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

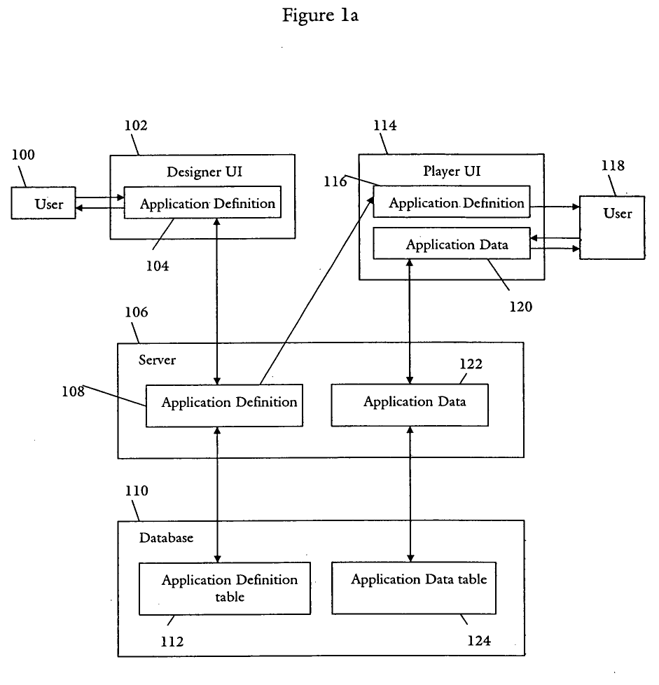

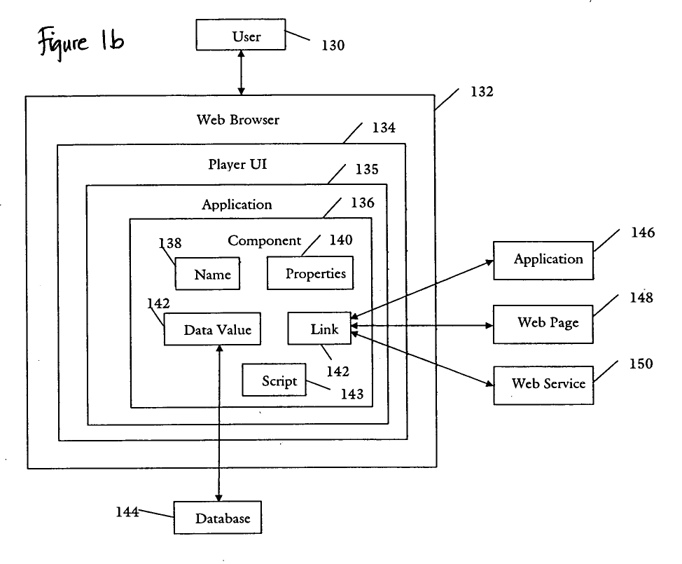

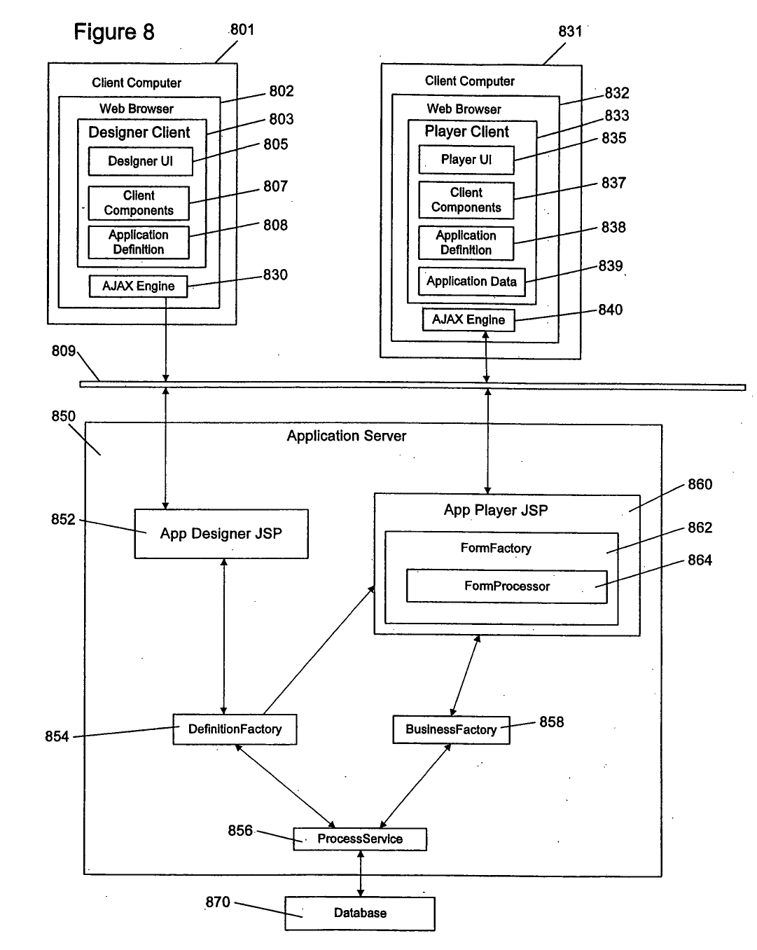

FIG. 1a is an illustrative drawing of an enterprise application design and deployment system according to one embodiment of the invention. A user 100 interacts with the Designer UI (user interface) 102 to design an application, e.g. a data input form, and a user 118, which may be the same user as user 100, or may be a different user, interacts with a Player UI (user interface) 114 to execute the application. The Designer UI and Player UI are software programs that are executed by a web browser running on a computer (shown in FIG. 8). Application Data 120 may be provided by the user 118 when the Player UI 114 executes the application. The Application Data 120 may include, for example, data entered by a user, such as data concerning a particular person or transaction. An application may include dynamic behavior, calculations, lookups, validations, and linkages to other data via, for example, a Uniform Resource Locator (URL) query string. The term application is used herein to refer to applications designed by the Designer UI, e.g. forms-based applications. The application is represented by an Application Definition 104, which is a structured list of components, e.g. text fields and logic, and other entities included in the application. A server 106 receives the application from the Designer UI 102 as an Application Definition 108 and stores the application in an Application Definition table 112 of database 110. The server 106 also sends the application to the Player UI 114 by retrieving an Application Definition 108 and any associated Application Data 122, e.g. values for the data input form, from the Application Definition table 112 and Application Data table 124, respectively, of the database 110. The user 118 provides Application Data 120 to the Player UI 114, which sends the Application Data 120 to the server 106, where the Application Data is converted to an intermediate format Application Data 122 and then stored in Application Data table 124. The server 106 and database 110 are software programs that are executed by computers (now shown).

FIG. 1b is an illustrative drawing of a browser-based application according to one embodiment of the invention. A web browser 132 executes a Player UI 134, which in turns executes an application 135. The Player UI 134 presents the application 135 to a user 130 via the web browser 132. The application 135 includes at least one component 136, which represents a user interface element such as a text box or a web link. The component 136 includes a name 138, which uniquely identifies the component. The component 136 is accessible by the name 138 in a Document Object Model associated with the web browser 132 in scripting languages, e.g. JavaScript™ or the like. The user 130 can provide computer program code as a script 143, which is associated with the component 136, for performing calculations based on the data value 142 in response to events, such as a user changing the data value 142. A script 143 can also set the data value 142. The component 136 also includes properties 140, which describe the component, e.g., the location of the component on a web page, and the type of component, e.g. a text box or link component. The properties 140 may include the name 138. The component 136 also includes a data value 142, e.g. a text string or numeric value, which can be specified by a user via the Player UI 134. The data value 142 is stored in a database 144 in a database column specified in the properties 140. The component 136 also includes a link 142, which has an associated Uniform Resource Locator (URL) that can refer to another application 146, or a web page 148, or a web service 150. The link 142 may send or receive the data value 142 to or from the application 146, the web page 148, or the web service 150, in response, for example, to input from the user 130. A description of the component 136, including the properties 140, is stored in the application definition 108 of FIG. 1a.

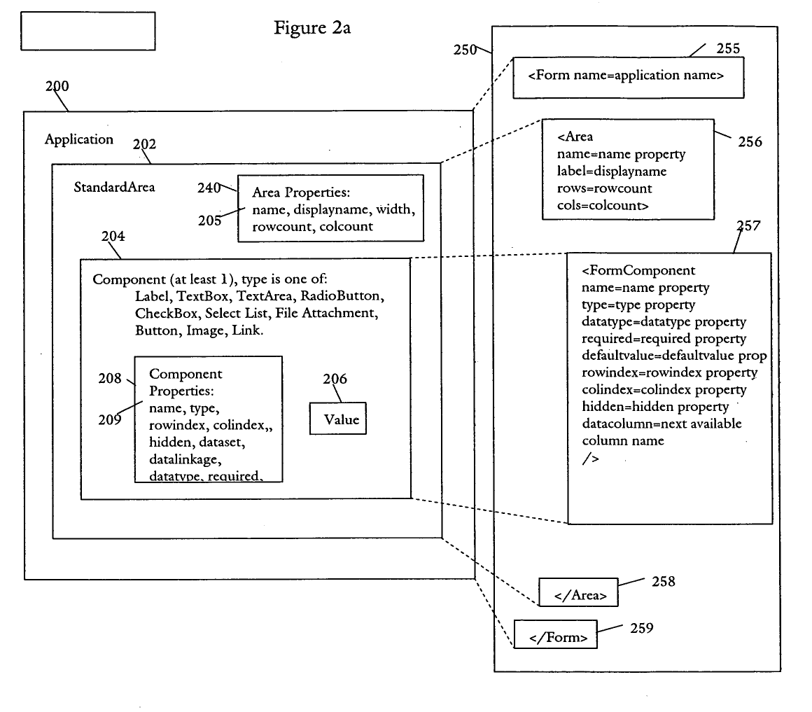

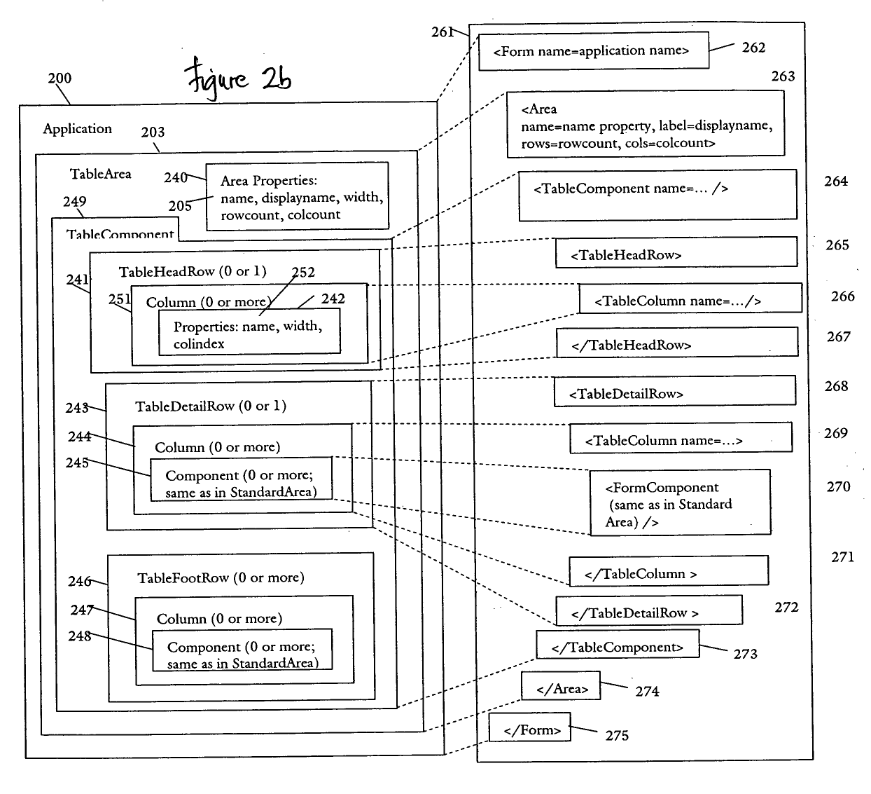

FIG. 2a is an illustrative drawing of an application definition according to one embodiment of the invention. An application 200 may include at least one StandardArea 202. A StandardArea 202 includes area properties 240 and at least one component 204. There is a second type of area, called a table area, which is shown as TableArea 203 in FIG. 2b. Table areas are described in more detail below. An area contains a grid of cells (nor shown) to allow users to place the components of an area in specific locations within the area. The locations are specified in terms of numeric row and column numbers. More specifically, the location of a component in a grid is specified by a row index value and column index value, where row 0, column 0 is the top left corner of the grid. The area properties 240 are a set of name-value pairs that describe the area. The area properties 240 include a name property, which specifies the name of the standard area 202, and width, rowindex, and colindex properties, which specify the width, grid row, and grid column of the area, respectively.

A component 204 is a user interface element of a specific type. The component 204 may be a Label, Text Box, Text Area, Radio Button, Check Box, Select List (e.g. a drop-down list), File Attachment, Button, Image, or link. Each component has associated properties. The component types and the properties associated with each component type are descrobed in the table below.

| COMPONENT TYPE | DESCRIPTION | PROPERTIES |
|---|---|---|
| Text Box | A text input field for | Name, Required, Readonly, |
| | reading data of a specific | Keyword Field, Data Type, |
| | type, e.g. string or numeric | Allowed Characters, Visibility |
| | data. Contains a text | Privileges, Edit privileges, |
| | value. | Routing edits (enable or disable), |
| | | data type, data format, max |
| | | characters, default value, action |
| | | (event handler). |
| Text Area | A text edit box for editing | Name, required, read only, |
| | a text string. Can display | keyword field, visibility and edit |
| | multiple rows of text and | privileges, routing edits (enable |
| | allow the user to edit the | or disable), allowed characters, |
| | text. Contains a text value. | data format, max characters, max |
| | | rows, max chars, default value, |
| | | action (event handler). |
| Date Picker | A data selector. Contains a | Name, required, read only, |
| | date value. | keyword field, visibility and edit |
| | | privilege, routing edits (enabled |
| | | or disabled), data format, default |
| | | value, action (event handler). |
| Check Box | A check box with two | Label, name, edit and visibility |
| | possible values (checked or | privileges, routing edits (enable |
| | unchecked). Contains a | or disable), initial state (checked |
| | boolean value. | or unchecked), action (event |
| | | handler). |
| Radio Buttons | A set of buttons, one of | Name, radio group, edit |
| | which can be selected. | privileges, routing edits, initial |
| | Contains a value | state, checked value, action |
| | representing a selected | (event handler). |
| | button. | |
| Combo Box | A drop-down box for | Name, required, keyword field, |
| | selecting one item from a | visibility and edit privileges, |
| | list of items. | routing edits (enable or disable), |
| | | data type, height, allow multiple |
| | | selections (yes or no), data |
| | | lookup source, action (event |
| | | handler). |
| Label | A text label for displaying | Name, layout style, alignment. |
| | information. Does not | |
| | contain a value. | |
| Button | A button that can be | Label, name, visibility and edit |
| | selected by a user to cause | privileges, action (event handler), |
| | an event handler to be | web service, link. |
| | called. | |
| Attachment | A file associated with the | Name, attachment type, visibility |
| | application. | privileges, action privileges. |
| Link | A web link that refers to a | Label, name, visibility and edit |
| | web page, web service, or | privileges, action (event handler), |
| | other resource. When the | web service, link (URL). |
| | link is selected in the | |
| | Player UI, the web page, | |
| | web service, or other | |
| | resource will be accessed. | |

The component 204 has component properties 208. If the component 204 is a data-holding component, e.g., a TextBox, TextArea, Select List, RadioButton, CheckBox, or File Attachment, then the component 204 has a value 206. The component properties 208 include a name property, which uniquely identifies the component within the area 204, a type property, e.g. label or text box, a label property, the value of which is displayed in the user interface for some component types, such as the label component type. The component properties 208 also include rowindex and colindex properties, which indicate the position of the component within the area, a hidden property, which indicates whether the component is to be displayed or hidden in the Player UI, and a datalinkage property, which indicates a source of values for the component, e.g. a database column containing values for a selection list, a datatype property, which indicates the permitted type of the value 206, and a required property, which indicates whether a value is required for the component 204.

The component properties 208 further include a dataset property, which may specify a database column in which the component's value 206 is stored. Because of the differences in data representations between the web browser's HTML-based data model, the Java object model used by the server, and the relational database model in which data is stored persistently, the XML application definition establishes a mapping between application data and database data, based on a component naming convention in which a unique name is assigned to each component. A DATASET attribute is also assigned to each component. The DATASET attribute specifies a database table and column name and thereby binds the component's value to a database column. The application data value of the component is stored in the specified database column. Multiple instances of application data are stored as separate database rows, so that each instance of application data, e.g. each Radiology Order Request instance associated with a Radiology Order Request application, is stored as a separate row in the database. The unique component name is generated by concatenating the names of enclosing components, such as areas and tables, with the component name and numeric counter values as described below.

Application definitions are specified using the Extensible Markup Language (XML). An XML document structure 250, shows how an application 200 that includes the StandardArea 202 can be defined using XML. The XML document structure has XML elements that correspond to the elements of the StandardArea 202. Specifically, the XML structure has a Form element 255, an Area element 256, and at least one FormComponent 257.

The Area element 256 and the Form element 255 enclose the FormComponent(s) 257, as shown by an Area element end marker 258 and a Form element end marker 259. The Form element 255 has a name attribute, which is assigned a value such as the name of the application. The Area element 256 includes four attributes: a name attribute, and label, rows, and cols attributes. The name attribute specifies a name for the area, and gets its value from an area name property 205 of Area properties 240. The area name property 205 is assigned a value, e.g. “area_{—}0”, by a string concatenation method based a counter value, e.g. 0, for the first area, that is incremented for each area in the Application 200. The value of the area name property 205 is assigned, for example, when the StandardArea 202 is added to the application. The label attribute specifies a name to be displayed for the area in the user interface, and gets its value from the dispalyname property of Area properties 240. The rows and cols attributes specify the number of rows and columns, respectively, in the area, and get their values from the rowcount and colcount properties, respectively, of Area properties 240. The FormComponent element 257 is an XML representation of the user interface component 204 and includes attributes, such as name and type attributes, which are assigned values from corresponding component properties 208 of the component 204, e.g. name and type properties, respectively. A component name property 209 is assigned a value, e.g. “comp_area_{—}0_{—}0_{—}0”, by a string concatenation method based on the type of component, e.g. “comp_”, the name of the enclosing area, e.g. “area_{—}0”, and a counter value that is incremented for each component 204 in the application, e.g. 0 for the first component. The value of the component name property 209 is assigned, for example, when the StandardArea 202 is added to the application. Generally, the name of a component in a StandardArea is generated by the following expression:
<ComponentType>+“_”+<AreaName>+“_”+<CounterValue>

where ComponentType is a string that corresponds to the type of the component, e.g. “comp” for data input components such as selection boxes, or “lbl” for label components, AreaName is the name of the enclosing Area, and CounterValue is a number that uniquely identifies the component within the enclosing Area. The counter values are assigned based on the number of components of the same type that have been previously processed in the enclosing Area. All non-alphanumeric characters in the name are replaced with underscores (_) when the component name is generated.

FIG. 2b is an illustrative drawing of an application definition according to one embodiment of the invention. An application 200 may contain at least one table area 203, which defines a table of rows and columns that will be presented to a user in the Application Player. A table area 203 includes area properties 240 and at least one TableComponent 249. A TableComponent 249 includes a TableHeadRow 241, a TableDetailRow 243, and zero or more TableFootRows 246. The TableHeadRow 241 describes the names, sizes, and positions of columns in the table. The TableHeadRow 241 includes zero or more column definitions 251. Each column definition 251 has column properties 241, which include a column name property 252, a width property that specifies the width of the column, and a colindex property that specifies the position of the column in the table.

A column name property 252 is assigned a value, e.g. “tcol_hdr_table_area_{—}1_{—}0”, by concatenating the type of the table row, e.g. “tcol_hdr” for a table header row, with the name of the enclosing TableComponent 249, e.g. “table_area_{—}1” and a counter value, e.g. 0, that is incremented for each column 251 in the application. The value of the component name property 209 is assigned, for example, when the StandardArea 202 is added to the application. Generally, the name of a component in a TableArea is generated by the following concatenation expression:
<RowType>+“_”+<AreaName>+“_”+<TableName>+“_+<TableColumnName>+“_”+<FormComponentName>+“_”+<CounterValue>

where RowType is a string based on the type of row. Specifically, RowType is set to tcol_hdr for header rows, dcol_dtl for detail rows, and fcol_ftr<counter> for footer rows, which have an associated counter value because there can be multiple footer rows), AreaName is the name of the enclosing Area, and CounterValue is a number that uniquely identifies the component within the enclosing Area. The counter values are assigned based on the number of components of the same type that have been previously processed in the enclosing Area. All non-alphanumeric characters in the name are replaced with underscores (_) when the component name is generated.

Table values are stored in detail rows, which are described by a TableDetailRow 243 that has zero or more columns 244. Each column has zero or more components 245 which store data values associated with column. The TableDetailRow is associated with a database table, e.g., a process_detail table (described below with reference to FIG. 14), The values of components 245 are stored in the database table. A TableFootRow 246 is similar to the TableDetailRow, except that the TableFootRow 246 is associated with a different database table, e.g. a PM table. A TableFootRow component 248 can include formulas that that specify a value for the component 248 based on the values of one or more TableDetailRow components 245.

An XML document structure 261 shows how an application 200 that includes the TableArea 203 can be described using XML. The XML document structure 261 has XML elements that correspond to the elements of the TableArea 203. Specifically, the XML structure 261 has a Form element 262, which corresponds to the Application 200. The Form element 262 encloses an Area element 263, which corresponds to the TableArea 203 and encloses at least one TableComponent 264. The Area element 263 has a name property, which is assigned to the value of the name property 205 of theTableArea 203. The name property 205 of the TableArea 203 is assigned a value based on a concatenation method as described above. There is one TableComponent 264 element for each TableComponent 249 object of the Application 200. Each TableComponent 264 element has attributes, which are assigned values from corresponding column properties 242 of the column 251, e.g. name, width, and colindex properties. The TableComponent element 264 encloses a TableHeadRow element 265, a TableDetail row 268, and zero or more TableFootRows (not shown). A TableHeadRow element 265 encloses zero or more TableColumns 266, which correspond to the columns 251 of the application 200. Each TableColumn element 266 has XML attributes with the same names and values as the properties 242 of the column 251. The TableDetailRow element 268 similarly corresponds to the TableDetailRow 243 of the application 200 and encloses zero or more TableColumn elements 269 corresponding to the columns 244 of the application. Table detail rows can contain components such as text boxes, so the TableColumn elements 269 of the TableDetailRow 268 include zero or more FormComponent elements 270 that describe components 245 of the application 200. The FormComponent elements 270 are of the same form as the FormComponent elements 257 of FIG. 2a. Finally, each element has an end marker that closes the element definition and completes the definition of the elements scope in the XML document structure 261. There is a TableHeadRow end marker 267, a TableColumn end marker 271, a TableDetailRow end marker 272, a TableComponent end marker 273, an Area end marker 274, and a Form end marker 275.

An application can be defined in a Web browser using client components implemented in a programming language, e.g. JavaScript, to create a representation of the application in terms of an object model. The object model includes objects such as an application object that has an array of area objects with properties, an area object that has an array of component objects, including basic components such as labels and text boxes with their properties, as well as table components. The table component object has an array of row objects, including a table head row object and a table detail row object that has an array of column objects, each of which has an array of component objects. A table foot row object would be similar to the table detail row object. The client components are also able to traverse the object in the object model to generate an XML application definition.

An XML application definition is generated by traversing the objects in the object model, e.g. by starting at the application object, looping through the application's area objects, generating the appropriate XML element begin marker for each area object, e.g. <Area> as shown in FIG. 2a, and then looping through the area's array of component objects, generating an XML FormComponent element for each component object, and generating XML attributes for the FormComponent, e.g. the name attribute, based on the component object's properties, e.g. the name property. A table component is traversed in a similar manner to generate an XML TableComponent element. The table head row, table detail row, and table foot row objects of the table component are each processed, and corresponding TableHeadRow, TableDetailRow, and TableFootRow XML elements are generated according to the XML structure 261 illustrated in FIG. 2b. Specifically, a table detail row object is processed by generating a <TableDetailRow> XML element and then looping through the table detail row's array of column objects. For each column object, a <TableColumn> XML element is generated with attributes, such as the column name, row index, and column index, taken from the column object. After all columns have been processed, a </TableHeadRow> end marker is generated. The table detail row is processed in a similar manner, by generating a <TableColumn> element before processing the columns, except that each column object in a table detail row has an array of components corresponding to the components that a user can add to a table column. When the XML is generated for a column in a table detail row, a <TableColumn> element begin marker is generated, then a <FormComponent > element is generated for each component in the column, as described above, and a </TableColumn> element end marker is generated after the last <FormComponent> element. For components that can contain data values, such as text areas, text boxes, selection lists, radio buttons, checkboxes, and attachments, a database column name for the data value is generated according to a convention based on the type of the component and a numeric index assigned to the component based on the number of components of the same type that have been previously processed. For example, the database column name for the first component that has a value of type string would be “sc1”, and the database column name for the third component that has a value of type Boolean would be “bc3”. Other components of the system use this same convention to locate the values of components in a database.

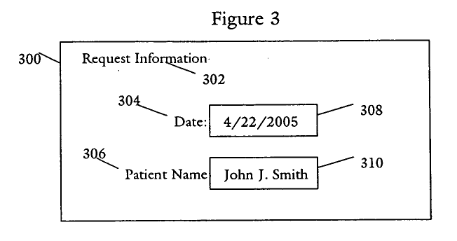

FIG. 3 is an illustrative drawing of an application user interface according to one embodiment of the invention. The application 300 has a name 302, “Request Information”, and four components. The components include a Date label component 304, a date input component 308 for reading a date value from a user, a Patient Name label 306, and a patient name input component 310, which may be, for example, a text input box or a selection list that allows a user to select a name from a list of names stored in a database.

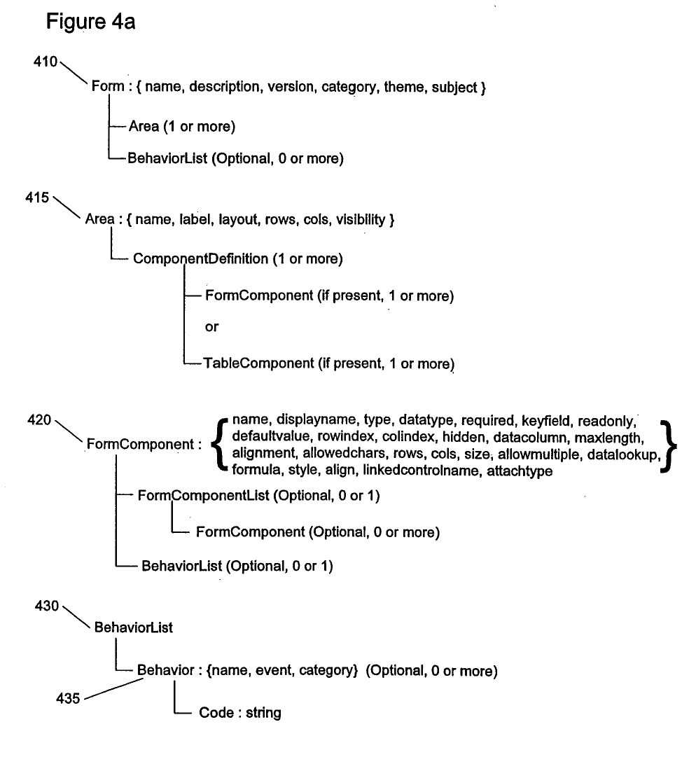

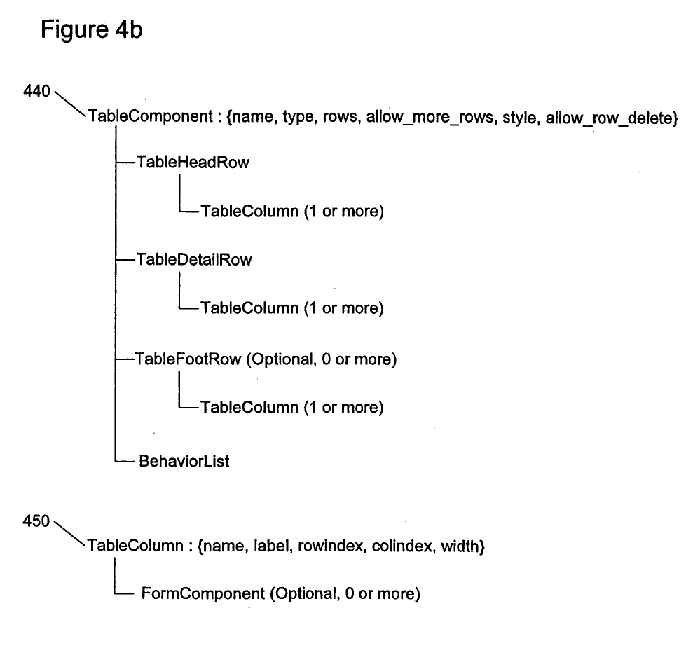

FIGS. 4a and 4b illustrate a schema describing a format for an application definition according to one embodiment of the invention. The schema may be, for example, an XML Schema describing the format of an XML document that represents an application. An application is stored, e.g. in a database, as an XML document that conforms to a Form schema 410. With reference to FIG. 4a, the Form schema 410 describes the structure and types of data in an application definition. A Form represents an application and has attributes (also referred to herein as properties), which are name-value pairs. The attributes of a Form include a name that specifies a name for the form, e.g. name=“Radiology Order Request”, a description that describes the form, a category, a theme, and a subject. A Form 410 includes one or more Areas and 0 or more BehaviorLists. An Area 415 provides for grouping and positional layout of components within a region defined by the boundaries of the Area and by cells arranged in rows and columns within the Area. Each Area 415 has properties, including a name, a label, a layout, a number of rows, a number of columns, and a visibility indicator. Each Area 415 includes one or more ComponentDefinitions. Each ComponentDefinition includes either one or more FormComponents 420, or one or more TableComponents 440.

A FormComponent 420 represents a component, e.g. a Text Box, and has attributes, including a name, a dispalyname, a type, a datatype, a required flag, a keyfield, a readonly flag, a defaultvalue, a rowindex which specifies the vertical position of the FormComponent 420 as a row number on an enclosing Area's grid, a colindex which specifies the vertical position of the FormComponent 420 as a column number on the enclosing Area's grid, a hidden flag, a datacolumn, which specifies a database column in which the value of the FormComponent is stored, a datalookup which specifies a database table from which a list of possible values for the FormComponent can be retrieved. A FormComponent 420 may include a FormComponentList, which may include one or more FormComponents 420. Note that the FormComponent definition is recursive and allows a FormComponentList to include multiple FormComponents. A FormComponent 420 may also include a BehaviorList 430.

A BehaviorList 430 may include Behaviors. A Behavior 435 represents executable code and has properties, including a name, an event, which may specify a type of event for which the behavior will be invoked, e.g. onchange, onClick, and the like, and a category. A Behavior 435 includes a Code element. The Code element includes code, e.g., JavaScript, which implements an event handler. The event handler will be called by the Player UI when a specific event occurs for the component, e.g. JavaScript code that is called when the component's value changes.

With reference to FIG. 4b, a TableComponent 440 represents a table and includes one TableHeadRow, one TableDetailRow, one optional TableFootRow, and one BehaviorList. A TableHeadRow, TableDetailRow, orTableFootRow includes at least one TableColumn 450. A TableColumn 450 describes the contents of a table column. A TableColumn has properties, including a name, a label, a rowindex, which is 0 by convention, a colindex which identifies the particular column described by the TableColumn, e.g. colindex=1 for the first column, and colindex=1 for the second column. A TableColumn also has a width property, which specifies the width of the column, e.g. as a percentage of the entire width of the table, such as “20%”. A TableColumn may include FormComponents. That is, a table column may contain form components such as text boxes.

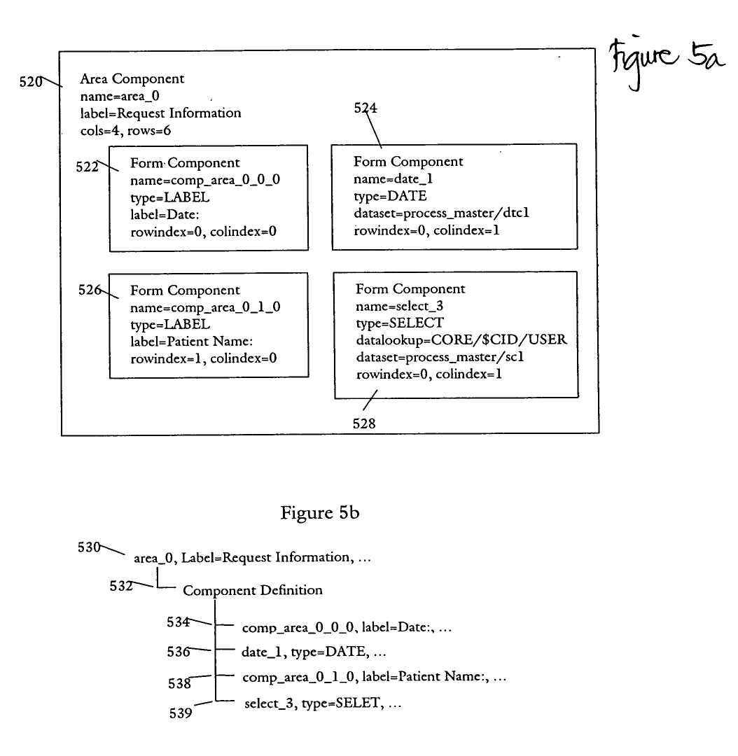

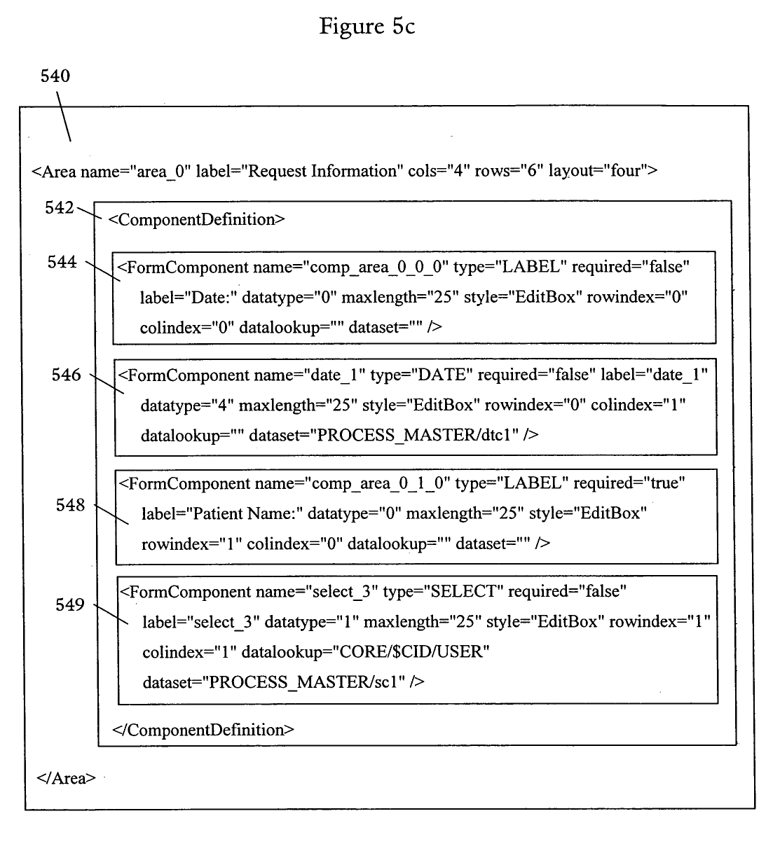

FIGS. 5a, 5b, and 5c are illustrative drawings of application definitions according to one embodiment of the invention. FIG. 5a shows an application definition 520 that corresponds to the application 300 illustrated in FIG. 3. The application definition 520 includes properties such as a name, area_0, and a label, “Request Information”. The,application definition 520 also includes four Form Component definitions corresponding to the four components of FIG. 3. A Date Label Form Component 522 describes the Date label, and has properties that include a name, comp_area_0_0_0, a type, “LABEL”, a label, “Date:”, and rowindex and colindex positions, 0, 0, which position the component at the top left of the area 520. A Date input form component 524 has a name, date_1, a type, “DATE”, and a dataset, “process_master/dtc1”, which indicates that a value entered by the user will be stored in the “dtc” column of the process_master database table. The rowindex and colindex properties of the Form Component 524 indicate that the component is to be placed in the second column of the first row in the Area 520.

A Patient Name form component 526 describes the Patient Name label, and has properties that include a name, comp_area_0_1_0, a type, “LABEL”, and a label, “Patient Name:”. A Patient Name input form component 528 has a name, select_3, a type, “SELECT”, i.e. selection list, a datalookup, “CORE/$CID/USER”, which indicates that the list of values for the selection list will be loaded from the USER column of the $CID database, a dataset, “process_master/sc1”, which indicates that a value selected by the user will be stored in the “sc1” column of the process_master database table. The rowindex and colindex properties of the Form Component 528 indicate that the component is to be placed in the second column of the second row in the Area 520.

FIG. 5b illustrates a tree-representation of an application definition according to one embodiment of the invention. The tree shown in FIG. 5b corresponds to the application definition shown in FIG. 5a. Each tree element includes the same name, value, and properties as a corresponding component of FIG. 5a. Specifically, the tree's root is an area_0 component, which has the same properties as the Area Component 520, and a Component Definition 532, which is an intermediate level that groups the components in the area 530. The Component Definition 532 includes the definitions of the Form Components of FIG. 5a, including a Date label 534 with name comp_area_0_0_0, a date input component 536 with name date_1, a Patient Name label 538 with name comp_area_0_1_0, and a patient name input selection list 539 with name select_3.

FIG. 5c is an illustrative drawing of an application definition according to one embodiment of the invention. The application definition 540 is a text document in Extensible Markup Language (XML) format and includes nested elements definitions. An Area element 540 defines the area, and corresponds to the Area component 520 of FIG. 5a. A ComponentDefinition element 542 contained in the Area element 540 corresponds to the Component Definition 532 of FIG. 5b. The ComponentDefinition element 542 contains four FormComponent elements 544-549, which correspond to the Form Component elements 522-528 of FIG. 5a. The FormComopnent elements 544-549 include XML attributes that correspond to the properties shown in FIG. 5a, such as the name, type, and label.

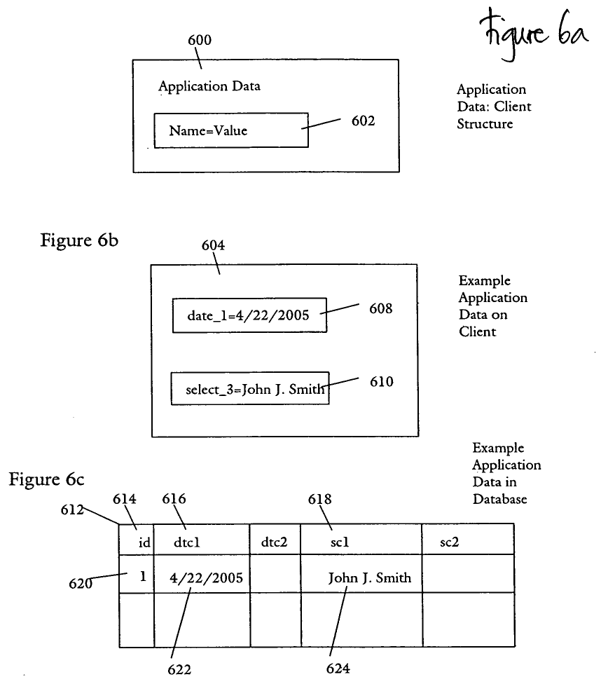

FIG. 6a illustrates application data 600, which includes a list of name-value pairs 602 corresponding to data values provided a user for an application according to one embodiment of the invention. With reference to FIG. 1a, the name-value pair format of application data 600 is used by the Player UI 114 to provide Application Data 120 to the Server 106.

FIG. 6b illustrates example application data according to one embodiment of the invention. The example application data 604 includes an example date value 608, with the name date_1 and the value “4/33/2005”, and an example selection list value 610, with the name “select_{—}3” and the value John J. Smith”. These application data values correspond to the values provided in data input component 308 and patient name input component 310, respectively.

FIG. 6c illustrates an example database table containing application data according to one embodiment of the invention. Database table 512, e.g. a table named process_detail stored in the Database 110 of FIG. 1a, has an “id” column 614, a “dtc1” column 616 for storage of the date component's value, and an “sc1” column 618 for storage of the selection list component's value. Database tables that store application data according to one embedment are described in more detail below with respect to FIG. 14. Other columns may be present as well for storage of additional component values, e.g. “dtc2” for a second date component and sc2 for a second selection component, and so on, up to an arbitrary number of columns One row of data is shown, which includes a value “1” for the “id” column 614, a value “4/22/2005” 622 for the “dtc1” column 616, and a value “John J. Smith” 624 for the “sc1” column 618.

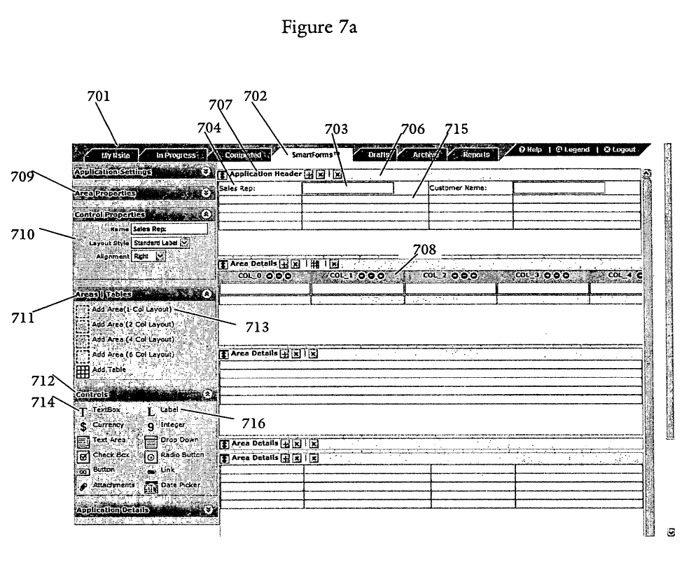

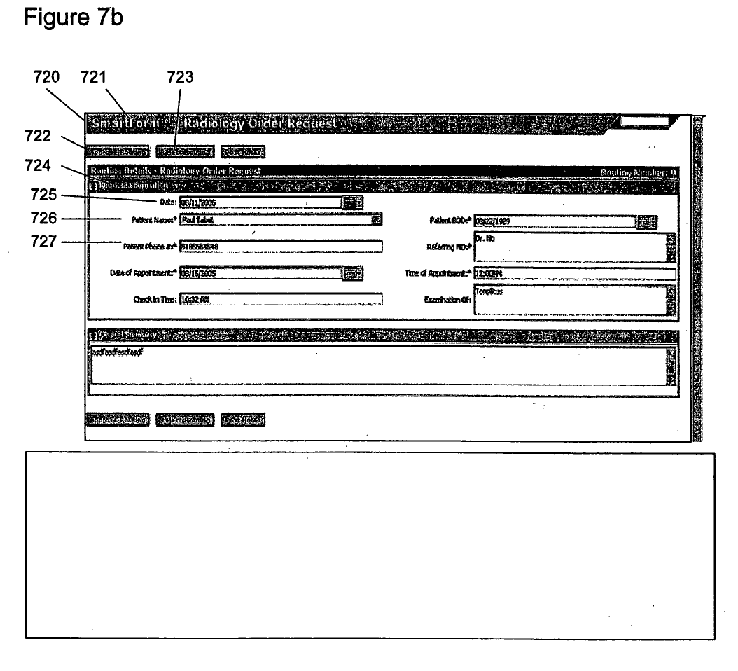

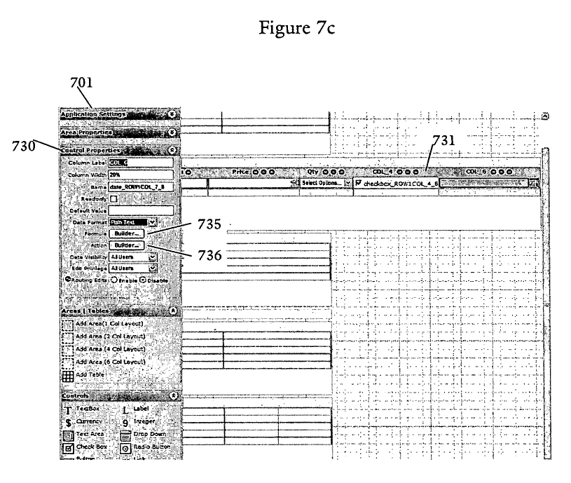

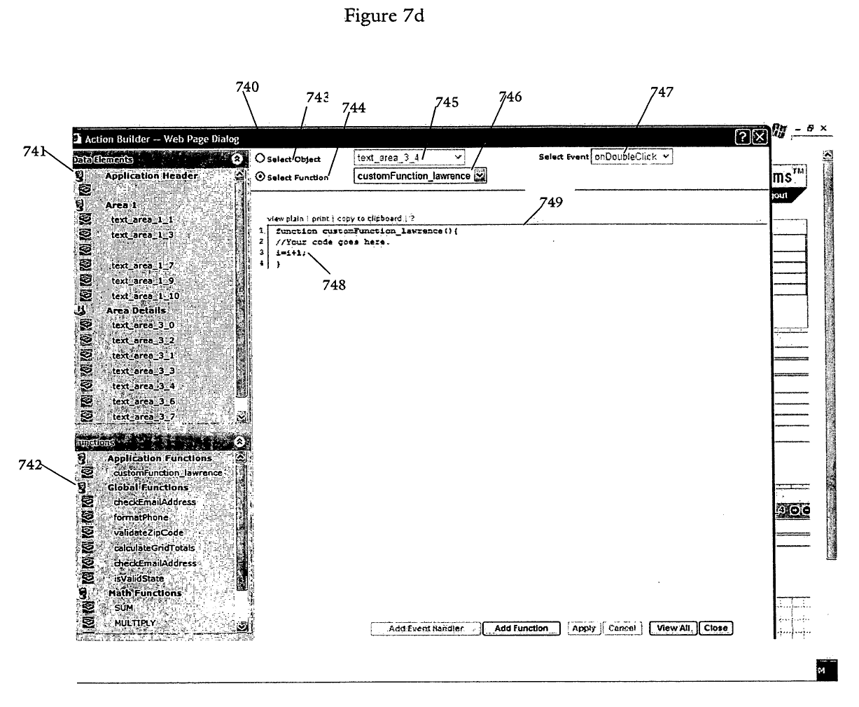

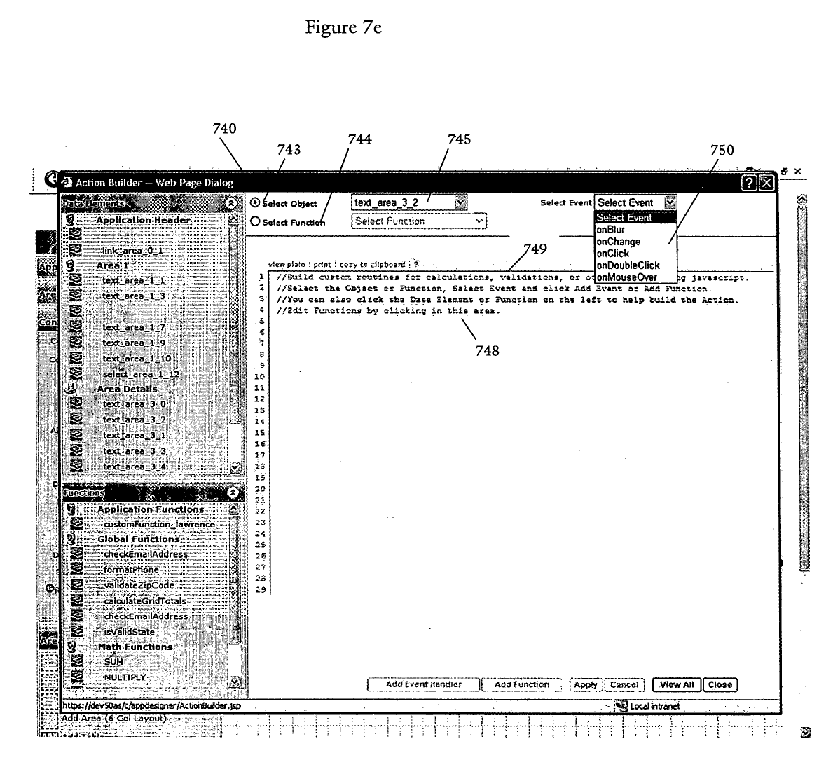

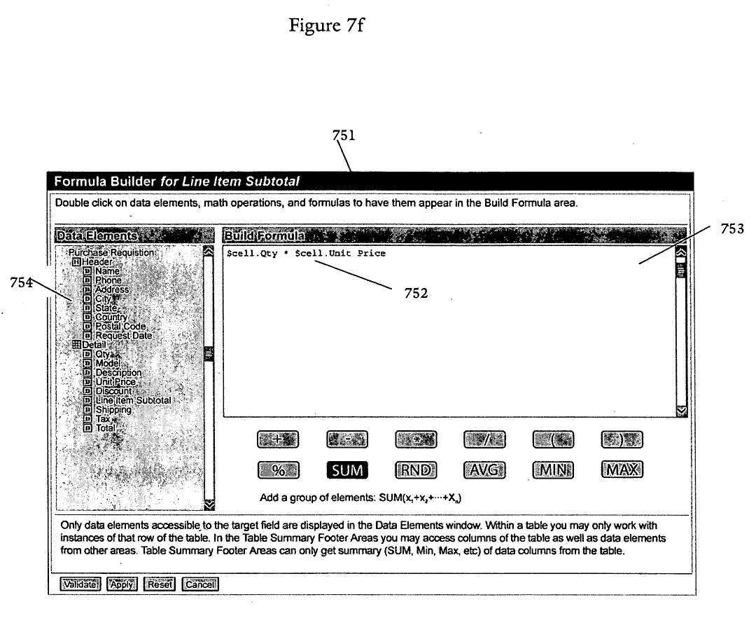

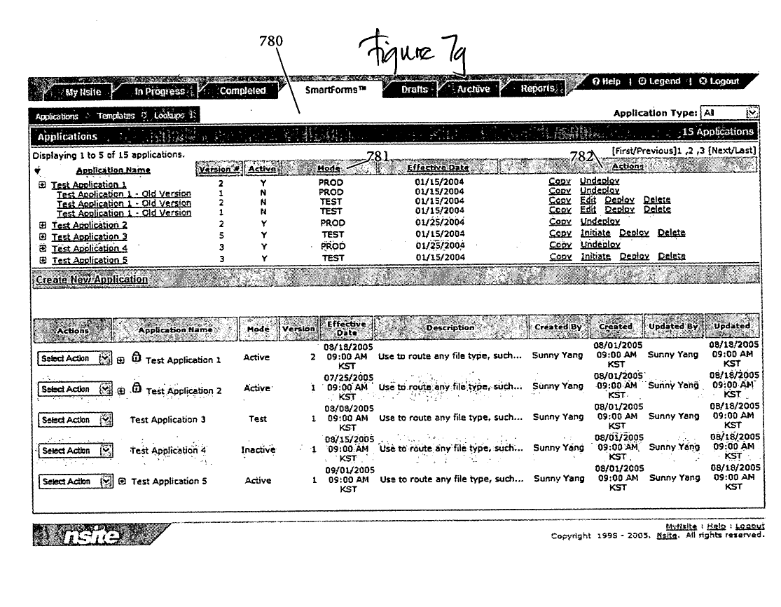

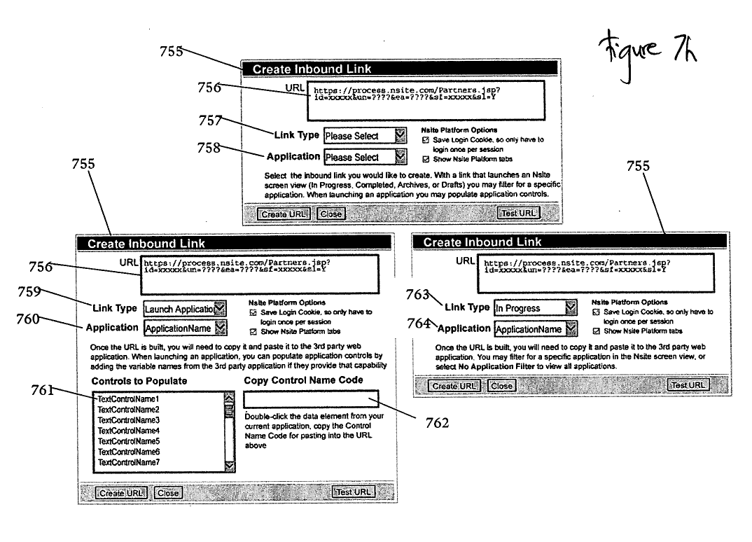

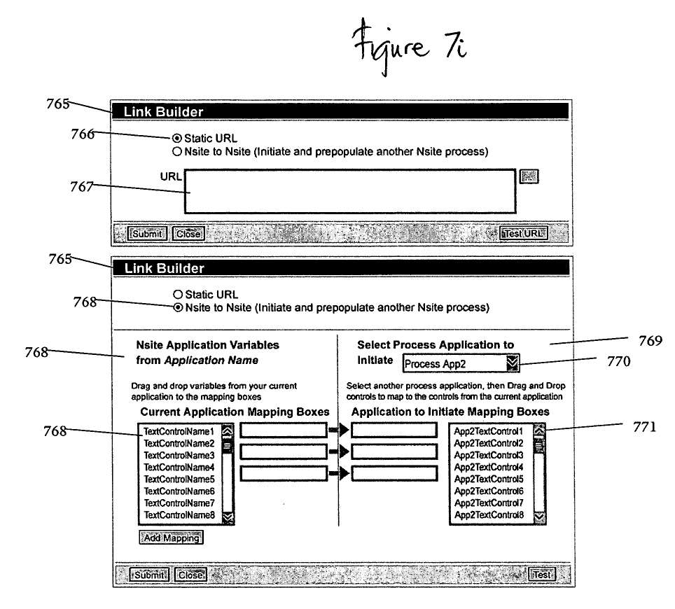

FIG. 7a is an illustrative drawing of an Application Designer user interface (UI) according to one embodiment of the invention. The Application Designer user interface (UI) 701 corresponds to the Designer UI 102 of FIG. 1a. The Application Designer UI 701 includes a workspace 702, which represents an application being designed, an area properties interface 709, a control properties interface 710, an areas palette 711, and a controls palette 712. The user can select a tool or a control from the palette, and can use the tool or control to place or drop areas, tables, and components, e.g., text boxes on the workspace. Components can be moved or dragged to alternate locations within the area as well after they are placed or dropped. The area palette 711 includes an Add Area tool 713 for adding a new area to the workspace, and the controls palette 712 includes a Text Box control 714 for adding text box components to the workspace. An area 707 includes a grid of cells. A cell 715 is empty when the area is added to the workspace, but a user can add one or more components, such as a label 704, to each cell by clicking on a control, such as label control 716 and dragging the control to the desired cell, such as the empty cell 715. As a result, a component, such as the label 704, will be added to the application in the desired cell 715. The cells allow the Designer UI to assign row and column positions to the components that a user adds to an area.

Once a component has been placed on the workspace, the user can set properties of the component to define specific behaviors, such as default values, table headings, mappings between controls and a database, and mappings between controls and web services. The workspace 702 includes a graphical representation of an example application definition that is being constructed by a user. In one embodiment, the application definition includes a data field 703 in which the user will enter data when the application is run in the Player. The data field 703 is associated with a label 704, which provides a textual description of the data field to a user. The workspace also includes an area 706 and a table area 708. The area 706 provides for grouping and positioning the locations of other fields, and contains the field 703 and the label 704. The table 708 includes a header row and five columns, named COL_0 through COL_4.

Palettes such as palette 712 shown in FIG. 7a provide easy access to the tools without cluttering the workspace. Palettes can include one or more tabs, each containing common properties. For example, all standard components are stored in the Components palette. Each palette provides a special function based on the selection in the designer workspace. Some palettes such as the Field Properties and Area Properties allow users to specify properties for the selected field/area.

FIG. 7c is an illustrative drawing of an Application Designer user interface (UI) according to one embodiment of the invention. The Application Designer user interface 701 includes a Control Properties interface 730, which allows a user to view and set properties of a selected component 731, which is a table column in this example. The table column's properties shown in the Control Properties interface 730 include a column label, a column width, and a component name. A user can change the values a property by entering a new value for the property. The Control Properties interface 730 also includes a Formula Builder button 735 and an Action Builder button 736. All Designer objects have unique properties. The properties for a numeric field have possible calculations while a drop down list may have a data source to populate the list of variables. The Control Properties interface 730 displays the properties available for the selected component type.

FIGS. 7d and 7e are illustrative drawings of an Action Builder user interface according to one embodiment of the invention. The Action Builder 740 allows a user to associate one or more actions with each component of the application. Actions include event handlers and custom functions. Event handlers are functions implemented in a programming language, e.g., JavaScript, which are called by the Player UI when associated events occur, e.g. when a user changes a component's value. Custom functions are functions implemented in a programming language, e.g. JavaScript, which can be called by event handlers and by other custom functions.

The Action Builder 740 allows the user to implement event handlers and custom functions by writing code in a programming language such as JavaScript The Action Builder 740 is displayed by the Application Designer user interface in response to a user request, e.g. in response to a user pressing the Action Builder button 736 of FIG. 7c.

The Action Builder 740 has a Select Function option 744 which a user can use to create create a custom function. The user can provide a custom function name 746, which will identify the custom function, and will also be the name by which the custom function is invoked from JavaScript. Then a user can then use a code editor 749 to write JavaScript code 748 that will be called when the custom function is invoked. In the example of FIG. 7d, the custom function simply increments the variable i.

The Player UI executes actions and evaluates formulas in response to events that are associated with user interface components such as buttons and tables. Events include user interface events, such as onClick, which occurs when the user has clicked on a table, or onchange, which occurs when a data value changes. The user interface event types include onBlur, onchange, onClick, onDoubleClick, and onMouseOver. Additional events are available for tables, such as onRowAdded. The event types are described in the table below.

| | |
|---|---|
| EVENT TYPE | DESCRIPTION |

Form Components

| | |
|---|---|
| onBlur | Called when focus moves away from a control |
| onChange | Called when data changes in a component.. |
| onClick | Called when a user clicks on a component. |
| onDoubleClick | Called when a user double-clicks on a |
| | component. |
| onMouseOver | Called when mouse pointer is positioned over a |
| | component. |

Grid

| | |
|---|---|
| onCellEnter | Caled when a user enters a table cell. |
| onModified | Called when a cell's contents are modified. |
| onAfterInsert | Called after a row is added to a grid. |
| onAfterDelete | Called after a row is deleted from a grid. |
| onColumnResize | Called when a column is resized. |

An event handler is a function implemented by code in a programming language, e.g. JavaScript. A user defines an event handler by providing implementation code for an associated event type. The event handler is called by the Player UI when an event of the associated type occurs. To define an event handler, a user first selects a component of the application in an object selection box 745. In the example of FIG. 7e, a component named text_area_3_2 has been selected. The user then selects an event type, e.g. onClick, from an event type menu 750 of event types available for the selected component, and provides JavaScript implementation code 748 using the code editor 749. Thereafter, when the Player UI is executing an application, the user's JavaScript code will be called whenever the specified event occurs for the specified object.

The Action Builder 740 includes a data element list 741, a function list 742, and a code editor 749. The data element list 741 is a list of the application's components. The data element list 741 has an entry corresponding to each area in the application, e.g. Area 1. Nested below each area entry is a list of the components in that area entry, e.g. text_area_1_1, text_area_1_3, and so on. The data element list 741 corresponds to a Document Object Model (not shown) associated with the application. The function list 742 includes user-defined functions, which are sometimes referred to herein as custom functions, and a set of commonly-used functions such as validateZipCode and SUM.

The code editor 749 allows a user to create and modify JavaScript implementation code 748 associated with a specified event 747, e.g. onClick, of a specified object 745, e.g., text_area_3_2, or with or a specified custom function 746, e.g. customFunction. The , JavaScript implementation code 748 associated with an event 747 of a specified object 745 will be called by the Player UI when the event occurs, e.g. when the user clicks on the specified object.

The JavaScript implementation code 748 for event handlers and custom functions can refer to any component of the application using JavaScript variables that are provided by the Document Object Model. A JavaScript variable is provided for each component of the application, and the variable has a name of the $<component>, where <component> is the name of the component. These component variables allow user-provided JavaScript code to read, write, and control other components. JavaScript code can get and set the value of a data-holding component, e.g., a TextBox, TextArea, Select List, Radio Button, CheckBox, or File Attachment by referring to a variable named $<component>.value.

The Action Builder 740 allows a user to select components from the Data Elements list 741 using, for example, a mouse pointer. When a component has been selected, the Action Builder 740 inserts a JavaScript variable name corresponding to the selected component into the code editor 749 at a current cursor position (not shown), so that the variable name becomes part of the JavaScript implementation code 748.

The JavaScript implementation code for custom functions and event handlers is stored in the XML application definition. In particular, the JavaScript code associated with a component is stored in a Behavior XML element of a BehaviorList element associated with the component. For example, an the JavaScript code for an onRowAdded event handler associated with a TableComponent would be stored as a Code element associated with a Behavior element, which is in turn associated with a BehaviorList element, which is associated with the TableComponent.

A link is a component that refers to an object such as an application or web page. The object may be located on a server specified by the link. The reference may be, for example, a Uniform Resource Locator (URL) that refers to a value on a web server. A Link can be associated with a Button component or a Link component.

FIG. 7h is an illustrative drawing of a Link Builder according to one embodiment of the invention. The Application Designer provides the Link Builder, which can be used to add two types of links, inbound links and outbound links, to an application. An inbound link is a reference that can be used to start or access a particular application on a server. The application may be, for example, with reference to FIG. 1a, an application previously created on the server 106 by the Designer UI 102. An inbound link includes the address or host name of a server, and parameters that identify an application on the server and provide default values for the application. An inbound link may appear on, for example, any web page. When a user selects an inbound link, for example, by clicking on the inbound link in a web browser, a request, e.g. in the HTTP protocol, is sent to the server specified in the inbound link along with the parameters specified in the inbound link. The server starts a Player UI, and loads the application specified by the inbound link into the Player UI, using the parameters in the link to identify the application and a user account under which to run the application. The server also provides the application with any data values, e.g., values for application components, specified in the inbound link's parameters. The server responds to the request by sending the application as a response, e.g. as an HTML/JavaScript web page in an HTTP response.

Inbound links are used, for example, when the originating web page or application is an external application such as Siebel or SalesForce.com. The user will use the Link Builder interface to build the link and then update the foreign application by pasting this link into the foreign application's user interface. The parameter values in an inbound link may be specified as attribute variables, for which values will be substituted by the Player UI when the link is presented to the Player UI. Attributes have the form name=value, where name is an attribute name and value is an attribute value. Attribute values are either literal values or placeholders. Placeholders have the syntax {!x }, where x specifies how to retrieve a value. An attribute variable appears in a link as, for example, un={!User_Username }, where {!User_Username} is a URL string replacement placeholder that will be replaced with actual values by the Player UI. For example, {!user_username} would be replaced with “John Smith” when the link is embedded and executed in another web page by a user named “John Smith”. The Player UI will retrieve an actual value for each attribute variable from the database and DefintionFactory, substitute the actual values into the link in place of the attribute variables, and pass the link with substituted values to the application. An outbound link is a reference to an object on a server, such as a web page on a web server. Outbound links may be included in button and link components of an application, and are displayed in the Player UI 114 of FIG. 1a. An outbound link may include attribute variables as described above. When a user selects an outbound link, the application substitutes the values into the query string attributes and launches the link as defined by the UI with the substituted query string values.

Links can be used to define actions such as launching a Business Object Lookup dialog. The link may define properties related to launching the Business Object Lookup dialog and may also include JavaScript code that will populate application components with data from the Business Object Lookup dialog. Links can refer directly to business objects, in which case each instance of a business object can be identified, displayed, and invoked via a URL. The URL includes a generic server resource string and a unique ID for the business object. The URL may also include an instance identifier to identify of the business object. The business object will be invoked when the URL is selected, e.g. by a user clicking the associated link in the Player UI,

Table rows can also be populated by a link by including a link to a business object in the table definition. In this case, the Business Object Lookup dialog returns an array of values, and a function loops through all the lookup values and populates the table rows with the values.

The Application Designer supports Conditional Sections, which provide the ability to conditionally hide or show sections of the user interface. Each Conditional Section can include multiple elements. A user of the Application Player can insert or remove the components on a conditional section when filling out a form, for example. Conditional sections are hidden by default in the Form Player until an associated condition becomes true. For example, a travel request form could include a conditional Car Rental section that is not shown by default. Users will see the Car Rental section if they click on an associated button in the Form Player user interface.

Applications created using the Application Designer can invoke Web Services when executed in the Application Player. In a typical Web services scenario, an application sends a request to a service at a given URL using the Simple Object Access Protocol (SOAP) over HTTP. The service receives the request, processes it, and returns a response.

The Application Designer provides a Web Services Builder that can be used to select a Web Service for a button or Link component. The Web Service may provide a value for the component, or, vice versa, the component may provide a value for the Web Service. The Web Services Builder allows the user to select the web service to be invoked for component. Specifically, the user can select a web service vendor, an object, and a field. The user can also specify the invocation type, which can be query, update, insert, or delete. When the user selects a vendor, the Web Services Builder displays a list of objects based on the selected vendor. The user then selects an object, and the Web Services Builder displays a table of fields. The user selects a field and an operation to perform on the field. For example, the vendor Siebel may have an object named Opportunity, which has a number of fields, each of which corresponds to a sales opportunity. The Web Services Builder is described in more detail in application Ser. No. ______, filed one the same date as the present application and incorporated herein by reference.

FIG. 7b is an illustrative drawing of an application displayed in an Application Player user interface according to one embodiment of the invention. An Application Player user interface, e.g. the Player UI 114 of FIG. 1a, presents the application to a user and receives application data from the user. FIG. 7b shows an example Radiology Order Request application 721 displayed in an Application Player UI 720. The radiology order request application 721 includes an area 724, which contains data fields that allow a user to enter application data. The input fields shown in FIG. 7b are a Date field 725, a Patient Name field 726, and a Patient Phone Number field 727. The application data values associated with the Date and Patient Name fields are “08/11/2005” and “Jane Doe”, respectively. Multiple different application data sets, sometimes referred to herein as instances of application data, may be associated with an application and stored using distinct identifying numbers or names. For example, the data values shown in FIG. 7b, including “08/11/2005”, could be saved as a first Radiology Order Request application data set, and another set of data values, for example, “8/12/2005” and “John Smith”, could be saved as a second Radiology Order Request application data set.

FIG. 7f is an illustrative drawing of a Formula Builder user interface according to one embodiment of the invention. The Formula Builder 751 allows a user to define component values in terms of a formula 752. The formula 752 is an expression that can include the values of other components. The formula 752 is $cell.Qty*$cell.UnitPrice, which sets the value of the component associated with the formula to the product of a Qty and an ItemPrice, which are values in of a ProductDetails component. A user can enter the formula in a Formula Area 753. A data element list 754 shows a list of data elements. Each data element corresponds to a data-holding component of the application. When a user selects a data element from the list 754, e.g. by using a mouse, the name of the selected data element will be inserted into the formula. A formula can be based on the value of any component, including components that are in tables.

In one embodiment, an application also includes the ability to route data, e.g., by sending a copy of the application and associated data to another user. Routing may be performed, by example, by sending a link to the application in an email message. A routing is a specification of how an application is to be routed, e.g. via email to a particular email address. The radiology order request application 721 has been routed to a recipient user via email. The recipient user can approve the routing by selecting the Approve Routing button 722, or reject the routing by selecting the Reject Routing button 723.

FIG. 7g is an illustrative drawing of an Application List user interface according to one embodiment of the invention. The Application List user interface 780 lists applications, templates, and lookups that have previously been created using the Application Designer. A user can select an application displayed on the Application List 780 for modification in the Application Designer or execution in the Application Player.

Each application has a name and a version number. The name is a string, such as “Radiology Order Request”, that identifies the application, and the version number is a number that is incremented when an application is modified in the Application Designer. Applications can be saved as templates. An application can be in one of three modes: design mode, test mode, or production mode.

FIG. 7h is an illustrative drawing of an Inbound Link Builder user interface according to one embodiment of the invention. A user can start the Inbound Link Builder 755 from the Designer UI, e.g., by selecting a Create Inbound Link option from an Application menu (not shown). A user can use the Inbound Link Builder 755 to create an inbound link 756, e.g. a URL, by specifying a link type 757 and an application 758. An inbound link 756 is a web link, e.g., a URL, which can be exported to an external document, e.g. a web page, or an external application. Subsequently, selecting the inbound link from a web application can create a new application and open a Player UI for the new application, or can open an application list showing applications of a specified type.

In particular, FIG. 7h shows three views of the Inbound Link Builder 755, each with a selected link type 757. The user can set the link type 757 to one of the following: Launch Application, In Progress, Completed, Archives, or Drafts. If the user sets the Link Type 759 to Launch Application, then the link will start an application in the Player UI, and the user can also specify an application name 760 and controls to populate 761, and the link will cause the specified application 760 to be started in a Player UI. The Copy Control Name Code 762 displays a control name code for an associated data element selected in the control list 761. The user can copy the Control Name Code 762 to the link 756. Values such as the Control Name Code 762 are copied to the link as placeholders. Actual values will be substituted for the placeholders by the Player UI when the application is executed. The user can alternatively set the Link Type 763 to In Progress, which means that the link will open an application list showing all applications that are in progress. Similarly, setting the Link Type 763 to Completed, Archives, or Drafts, would configure the link to open an application list showing applications that are completed, archived, or drafts, respectively.

FIG. 7i is an illustrative drawing of an Outbound Link Builder user interface according to one embodiment of the invention. An outbound link, e.g. a URL, may be associated with a Button or a Link component of the application. An outbound link can open a web page specified by a static URL, or can initiate execution of another application. A user can use the Outbound Link Builder 765 to create an outbound link, e.g. a URL. A user can start the Outbound Link Builder 765 from the Designer UI, e.g., by clicking on a Link Builder button (not shown) that is present on the Control Properties panel 710 of the Designer UI 701 of FIG. 7a. The user can select either Static URL 766 or Nsite to Nsite 768 to indicate whether the link is a static link, e.g. to an arbitrary web page, or a link to another application. If the user selects Static URL 766, then the user can provide the link, e.g., as a URL, in the link box 767. If the user selects Nsite to Nsite 768, then the user can select an application to initiate 770. The user can define an input data mapping for the application to initiate 770 by selecting controls from a current application control list 768 and, for each selected control, selecting a corresponding control of the application to initiate from a control list 771 for the application to initiate 770. Subsequently, when the link is followed, e.g. when a user clicks on an associated Link component in the Player UI, the application to initiate 770 will be started, and the controls of the application to initiate 770 will be initialized with values from the controls of the current application as defined by the input data mapping. For example, if TextControlNamel is selected from the current application control list 768, and App2TextControl3 is selected from the control list 771 for the application to initiate, then the value of TextControlNamel would be copied to App2TextControl3 when the link is followed in the Player UI.

FIG. 8 is an illustrative drawing of client and server components of an enterprise application design and deployment system according to one embodiment of the invention. FIG. 8 is a more detailed view of the components illustrated in FIG. 1a. Client computers 801 and 831 are running web browsers 802 and 832, respectively. A web browser 802 is shown running an Application Designer client 803. A user interacts with the Application Designer client 803 to create an application. In one embodiment, the Designer client 803 saves the application as an application definition 808, which is a description of the application in a format such as XML. A second web browser 832 is shown running an Application Player client 833. A user interacts with the Application Player client 833 to provide data to an application and view data associated with the application. The Player client 833 allows users to load and execute application definitions and save and load application data. Note that the arrangement of the two clients on two different computers as shown is one of many possible arrangements. The Player client can, for example, alternatively be run on the same client computer 801 in the same web browser 802 as the Designer client. The web browser, e.g., Microsoft Internet Explorer™, Mozilla Firefox™, or the like, is able to load and display a web page specified by a Uniform Resource Locator (URL) from a server 850 running on a server computer (not shown) via a computer network 809. The web browser allows the clients 803 and 833 to run on client computers 801 and 831 without being installed directly on the client computers 801 and 831. The web browser downloads the clients 803 and 833 from the server 850 via the computer network 809, presents user interface portions of the clients to a user, executes any code associated with the clients, e.g. JavaScript code, allows the user to interact with the client user interfaces, and sends any results of the user interaction to the server. The web browser also includes an AJAX Engine 830, which is a software library that is loaded into the web browser from the server 850. The AJAX Engine improves the user experience by maintaining information so that the client need not send a request to the server in certain situations, so that there is no delay between a user's action and the client's response in these situations. The AJAX Engine 830 also provides services used by the clients 803 and 833.

The Designer client 803 includes client components 807, and the Player Client 833 includes client components 837. The client components include JavaScript Definition object that implement a hierarchy of forms, areas, components, tables, properties, behaviors, methods, requests, responses, and parameters.

The Designer UI 805 and Player UI 835 are presented to a user as web pages. The web pages are provided by the server 850 to the web browsers 802 and 832 via the network 809 when a user enters a corresponding URL into the web browser. On the server, these web pages are App Designer JSP 852 and App Player JSP 860, for the designer and player, respectively. The web browser presents clients 803 and 833 to the user by displaying web pages generated by the App Designer JSP 852 and App Player JSP 860, respectively. These generated web pages include JavaScript code that uses JavaScript Client Components 807 and 837 to implement the Designer and Player user interfaces.

The App Designer JSP 852 is a page controller JSP that implements several action commands, including getDefinition, saveDefinition, saveDefinitionAsTemplate, createNewVersion, and lockdefinition, as described in the table below. These operations are invoked in response to corresponding user requests from the Designer UI 805 and Player UI 835.

| COMMAND | DESCRIPTION |
|---|---|
| getDefinition | Returns a Definition Javascript object. |
| saveDefinition | Saves a Definition to the database and |
| | unlocks the Definition for edits by |
| | other users. |
| saveDefinitionAsTemplate | Saves a Definition to the database and marks |
| | it as a template. |
| createNewVersion | Creates a new version of a Definition. |
| lockDefinition | Marks a Definition as locked before a user |
| | edits the Definition. |

The application server 850 may be JBoss™ from JBoss Inc. of Atlanta, Ga., or the like, and may include a container framework, e.g. the Spring Application Framework from Interface21 of London, United Kingdom, or the like, and provides services for executing the App Designer JSP 852 and the App Player JSP 860. These services may include a web server, HTTP network communication, fault tolerance, load balancing, application management, transaction management, dependency injection, and internationalization. The database 870 may be a relational database, e.g. Oracle™ or the like, and runs on a database server computer (not shown).

The application server 850 may be run by a service provider to provide the App Designer and App Player as hosted applications.

The application server 850 also includes a DefinitionFactory 854 a FormFactory 862 and a BusinessFactory 858. The DefinitionFactory 854 is a Java object that uses an object-relational mapping tool to create ProcessDefinition objects that correspond to rows in a process_definition database table. A ProcessDefiniton object contains an application definition in the form of an XML document. The DefinitionFactory 854 can generate a new empty application definition, or can load an existing application definition from the database 870, in which case the application is retrieved from the database 870 using an application identifier as a key. The application definition is used to render user interface portions of the App Designer JSP 852 and FormPlayer JSP 860. The ProcessService 856 provides an object-relational mapping for saving and loading the application definition and application data o and from the database 535.

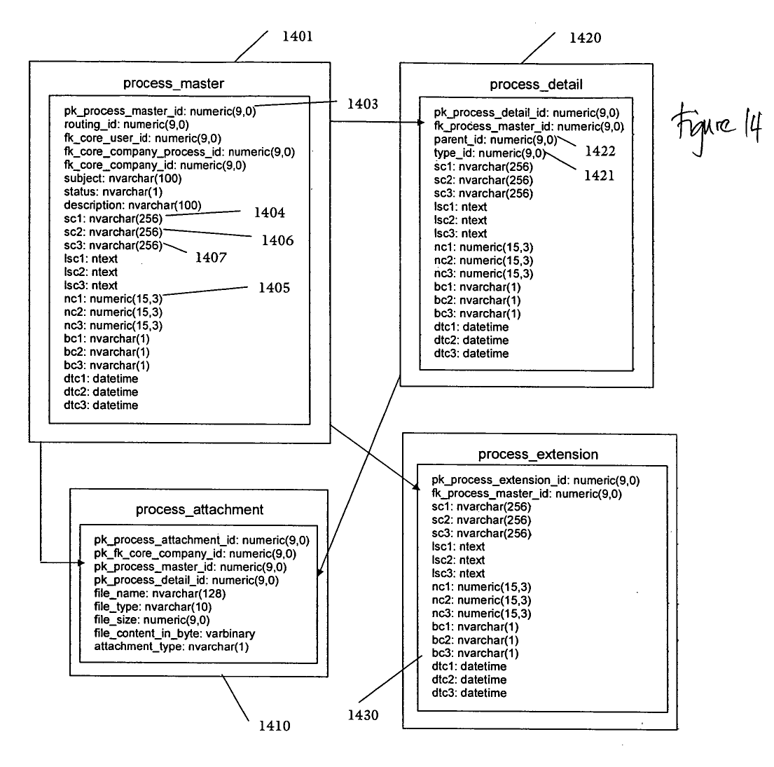

The FormFactory 862 uses an XML application definition to render an HTML representation of the application, which may include application data retrieved from the database 870 if application data has previously been saved. The HTML representation is sent to a browser 832 running a Player Client 833 by the FormPlayer JSP 860. The FormPlayer JSP 860 uses a FormProcessor 864 to process incoming requests, e.g. HTTP messages, received from the Player Client 833 by extracting applicaton data, e.g. in the form of HTTP parameters, from the request and passing the application data to a BusinessFactory 858 for storage in the database 870. The ProcessService 856 uses an object-relational mapping tool, e.g. Hibernate from JBoss Inc., to convert the application definition from the server programming language, e.g. Java, to and from a relational table format such as that shown in FIG. 6c for persistent storage in the database 870. In particular, the application definition is represented in Java as a ProcessDefinition object, which is stored in a process_definition table, and the application data is represented in the Java programming language as ProcessMaster, ProcessDetail, ProcessAttchment, and ProcessExtension Java objects, which are stored in a corresponding process_master table and related process_detail, process_attachment, and process_extension tables, respectively. These tables are described below with respect to FIGS. 13 and 14.

With reference to FIG. 1a, after a user 100 has provided an Application Definition 104, e.g., a definition of an application for collecting data or executing a transaction, to Player UI 102, the user 100 may invoke a save command in the Designer UI 102 to cause the Application Definition 104 to be saved to persistent storage such as a database 110.

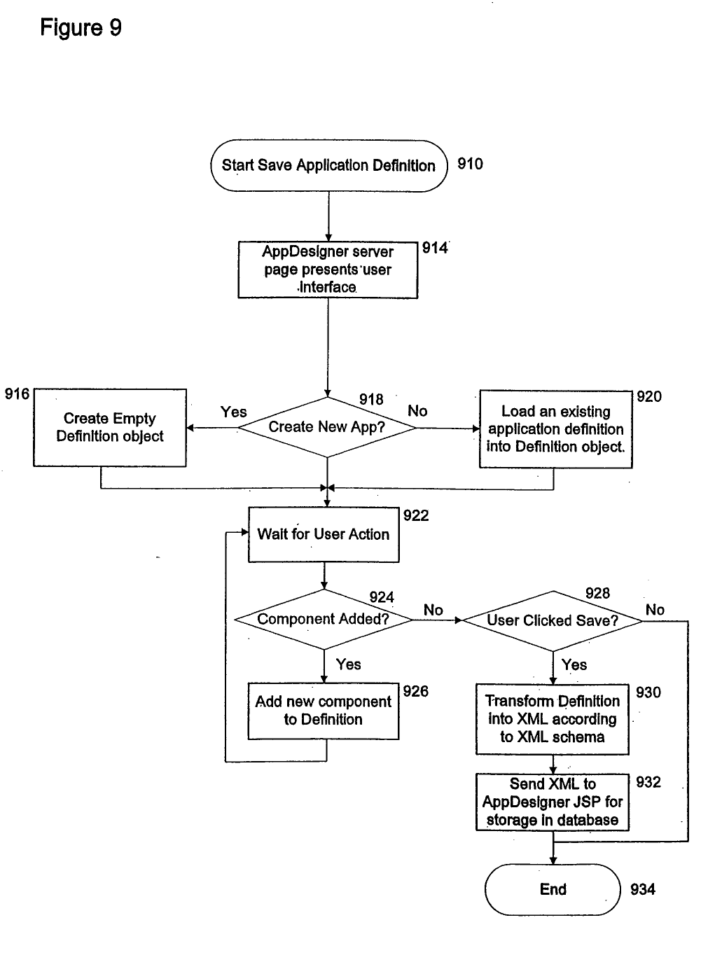

FIG. 9 is a flowchart illustrating a method of saving a specified application definition to persistent storage, e.g. to a database, according to one embodiment of the invention. This method saves an application to a database by creating an XML application definition from user interface components created by a user in the Designer UI 102 of FIG. 1a and sending the application definition to the Server 106 of FIG. 1a. This method is executed by a web browser running the Designer UI when a user requests that an application be saved, e.g. by clicking a save button in the Designer UI. The method begins at block 914, in which the App Designer UI presents the user interface. Next, block 918 checks whether a new application is being created or an existing application is being modified. If a new application is being created, an empty Definition JavaScript object is created at block 916. If an existing application is being modified, the existing application is loaded at block 920 into a Definition object. In either case, the method now waits for the user to add components to the form. When a new component such as a text field is added, the Definition is updated to include the new component, e.g. a JavaScript object representing the text field is added to the Definition. A loop starting at block 922 waits for a user action, such as the addition of a component to an area, or a mouse click on a control button such as a save button. After such a user action is received, block 924 determines if a component has been added to an area by the user, in which case the component is added to the Definition at block 926, and the loop returns to block 922 to wait for another user action. If block 924 instead determines that the user has not added a component, then block 928 determines if the user has clicked save. If the user did click save, then block 930 transforms the Definition into an XML document according to the XML schema, and block 932 sends the XML document to the App Designer JSP via HTTP for storage in database tables. The App Designer JSP receives the XML document, creates a ProcessDefinition object containing the XML document, and passes the ProcessDefinition object to the ProcessService, which stores the XML document in the process_xml column of the process_definition table. Note that although only two types of user actions are shown in FIG. 9, adding a component and clicking save, the application designer includes support for additional user actions that are not shown in FIG. 9, such as deleting, moving, or editing a component, loading a form, and so on. When the method of FIG. 9 is complete, the specified application has been saved to persistent storage as an XML document.

With reference to FIG. 1a, a user 100 of the Designer UI may invoke a command to load a previously-saved application definition from the database 110 into the Designer UI. After the application definition has been loaded, the Designer UI can be used to modify the application and subsequently save any changes. When the modified application is saved, it will be saved with an associated version identifier that uniquely identifies the application. The previous version of the application definition will not be deleted. Any references to the previous application definition, e.g. a reference in an email message that includes the application as an attachment, will include the version number of the previous application definition, and will continue use the previous application definition.

A user 118 of the Player UI 114 may invoke a command to load a previously-saved application, including application data, such as data concerting a particular person or transaction, data from the database 110 into the Player UI 114. After the Application Data 120 has been loaded, the Player UI 114 can be used to modify the Application Data 120 and save the modifications by invoking the save command as described above with reference to FIG. 9.

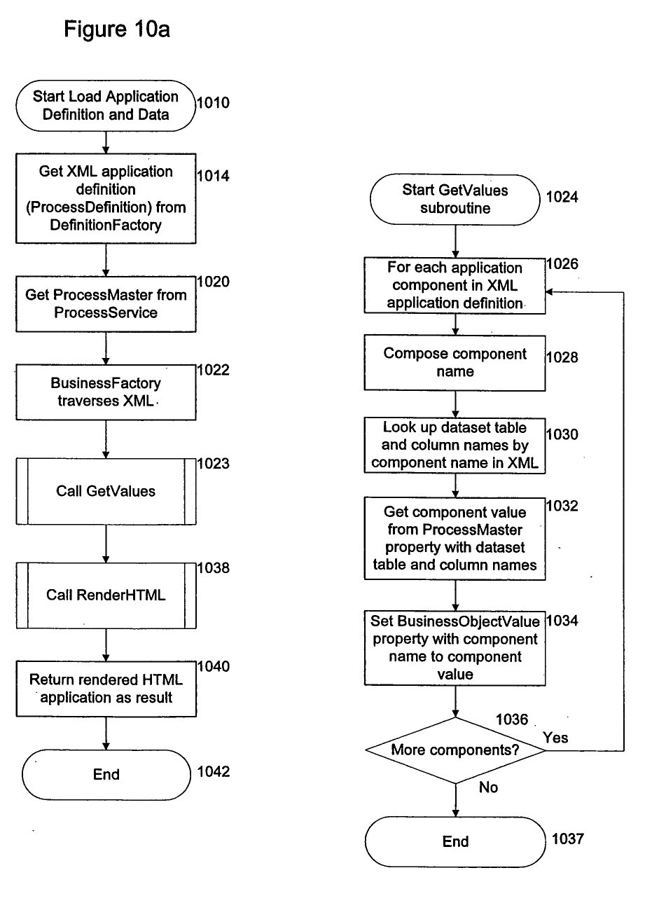

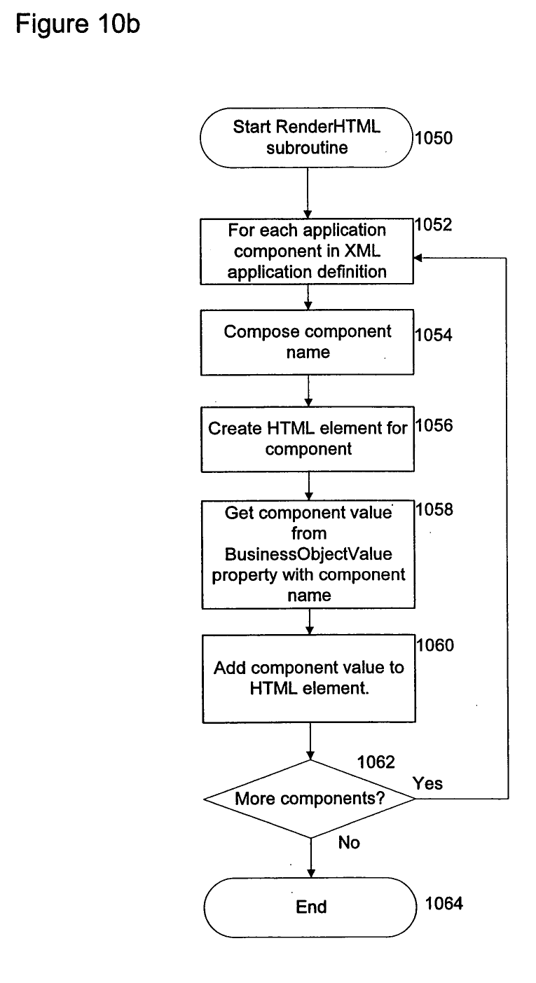

FIG. 10a is a flowchart illustrating a method of loading an application according to one embodiment of the invention. This method loads a specified application definition and a specified instance of application data, if such an instance exists, into the Application Player. This method is executed on an application server by the App Player JSP page. The method produces a web page that includes HTML and JavaScript elements. The web page can be displayed in a web browser to provide the Application Player UI. The method of FIG. 10 is executed, for example, when a user selects a specific application and application data instance to execute in the Application Player. The method is described in terms of objects, such as a DefinitionFactory that produces a ProcessDefinition, which represents an application. These objects are instances of corresponding classes that include code and data. The method and its associated objects may be implemented in an object-oriented programming language, e.g., Java™, C++, C#™, or the like. The method starts at block 1014 by retrieving an XML application definition for a specific application. The XM application definition is represented as a ProcessDefinition Java object, which is retrieved from a DefinitionFactory. The DefinitionFactory retrieves the ProcessDefinition from a database via a ProcessService (not shown). The ProcessService reads the data values necessary to construct the ProcessDefinition, including the XML document describing the application, from the database. At block 1020, a ProcessMaster object containing a previously-saved application data instance is loaded from the database via the ProcessService. If no application data instance has previously been saved, block 1020 has no effect. Application data may have been previously-saved by, for example, a previous execution of the Application Player in which the user saved the application data. Block 1022 calls a GetValues subroutine to load the application data from the process_master table into a BusinessObjectValue object. Block 1038 calls a RenderHTML subroutine to create an HTML web page that includes any loaded application data and can be used by a web browser to provide the App Player UI. Finally, block 1040 returns the HTML web page as a result, e.g. by sending the HTML to a browser as an HTTP response. The HTML web page then be displayed in a browser by the application player.

The GetValues and RenderHTML subroutines both traverse the XML application description. These subroutines process an XML application definition data structure.

To load application data from the Database 110 of FIG. 1a, the GetValues subroutine traverses the XML application definition to create a BusinessObjectValue object that contains the application data values retrieved from the database for a particular instance. These data values are loaded from a database row that corresponds to a specified application data instance. The GetValues subroutine begins at block 1026 by starting a loop to process each component in the XML application definition. The components are processed using a traversal that visits each component in the tree formed by the XML nodes. For each component, the subroutine gets the associated data value from the process_master table and stores the data value in the BusinessObjectValue. Specifically, for each component, block 1028 composes a unique component name using the same concatenation method that is used when components are initially added to the application by a user, as described above with reference to FIGS. 2a and 2b.

Block 1030 uses the unique component name to look up dataset table and column names in the XML application definition. The dataset table and column names identify the database column in which the data value for the component is stored. At block 1032, the component's data value is retrieved from the database by requesting the value of the database column from the process_master table. At block 1034, the component's data value is stored in the BusinessObjectValue as a name-value pair, with the unique component name as the name portion of the pair, and the component's data value as the value portion of the pair. Finally, block 1036 checks if there are more components in the XML document to process. If so, the loop repeats for the next component.

The RenderHTML subroutine illustrated in FIG. 10b traverses an XML application definition to generate an HTML document according to one embodiment of the invention. The App Player client displays the HTML document to provide the App Player UI. The RenderHTML subroutine begins at block 1052 by starting a loop to process each component in the XML application definition. The components are processed by the recursive-bypass method described for the GetValues subroutine above. For each component, the RenderHTML subroutine generates a corresponding HTML element, gets an associated data value from the BusinessObjectValue, and sets the value of the HTML element to the associated data value. Specifically, for each component, block 1054 composes a unique component name and HTML ID by concatenating parent component names, such as an Area name, with the component name and a numeric counter value, as described for the GetValues subroutine above. The unique HTML name and ID are embedded in the HTML produced by the RenderHTML subroutine. The unique HTML name is used for request processing when application data to be saved is received from a browser, and the HTML ID is used in the JavaScript code. At block 1056, an HTML element is generated for the application component. An Area XML component can be rendered into a <TABLE> or <DIV> HMTL element. A CheckBox XML component is converted to an EDITBOX of type CHECKBOX in HTML. The XML attributes, e.g. DATASET, of a component are copied to HTML element generated for that component. At block 1058, the component's data value is retrieved from the application data, and at block 1060 the data value is added to the HTML element. If there is no data value associated with the component, e.g. because no data has been saved, then blocks 1058 and 1060 do nothing. Finally, block 1060 checks if there are more components to process. If so, the loop repeats. Otherwise, the subroutine returns the generated HTML elements as a result value and ends.

With reference to FIG. 1a, after a user 118 has provided Application Data 120, e.g. data concerning a particular person or transaction, to Player UI 114, the user 118 may. invoke a save command in the Player UI 114 to cause the Application Data 120 to be saved to persistent storage such as a database 110.

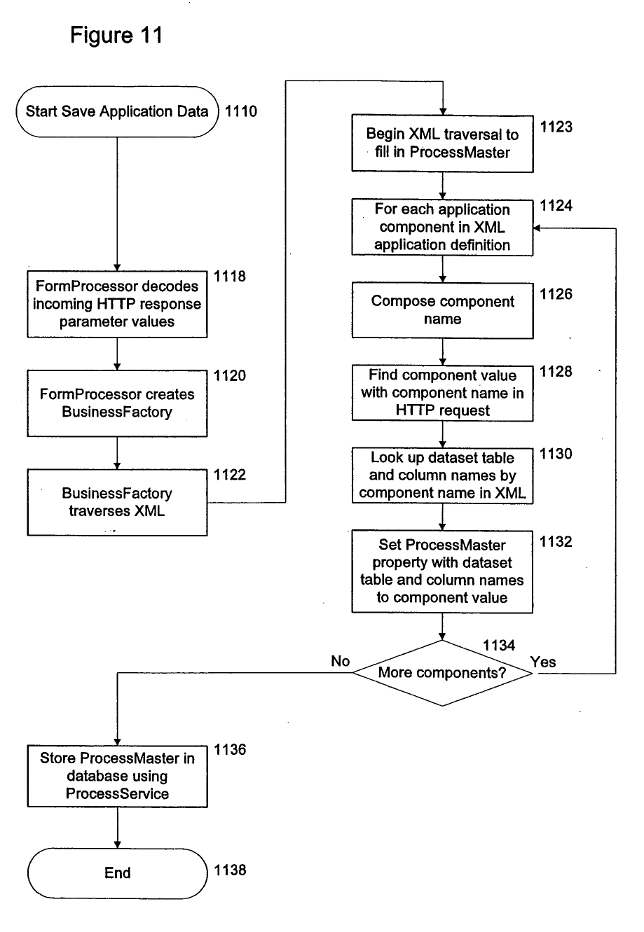

FIG. 11 is a flowchart illustrating a method of saving application data according to one embodiment of the invention. This method is invoked by the Player JSP server page when a user invokes a save command in the Player UI. The data values are submitted by the Player UI as HTTP parameters in an HTTP response message sent from a browser. The method saves the data values to a database. Specifically, the method begins when an HTTP response message containing application data is received from an Application Player client. At block 1118, a FormProcessor object decodes the HTTP-format parameters from the HTTP response message. At block 1120, the FormProcessor creates a BusinessFactory object. At blocks 1124-1134, the BusinessFactory traverses the XML application definition, which is available in the Player UI's memory. The traversal begins at block 1124, which starts a loop iteration for each component in the XML application definition. The components are processed by the recursive bypass method described for the GetValues subroutine above. For each component, the method writes the corresponding value from the HTTP response to the database. Specifically, for each component, block 1126 composes a unique component name by concatenating parent component names, such as an Area name, with the component name and a numeric counter value, as described for the GetValues subroutine above. At block 1128, the unique component name is used as a lookup key to retrieve from the HTTP response a parameter that has a name equal to the component name. The retrieved parameter is the application data value for the component. The value is then stored in the database by looking up the database table and column names at block 1130 and setting a property of the ProcessMaster, ProcessDetail or ProcessExtension object, for which the property's name is equal to the column name, to the retrieved parameter.

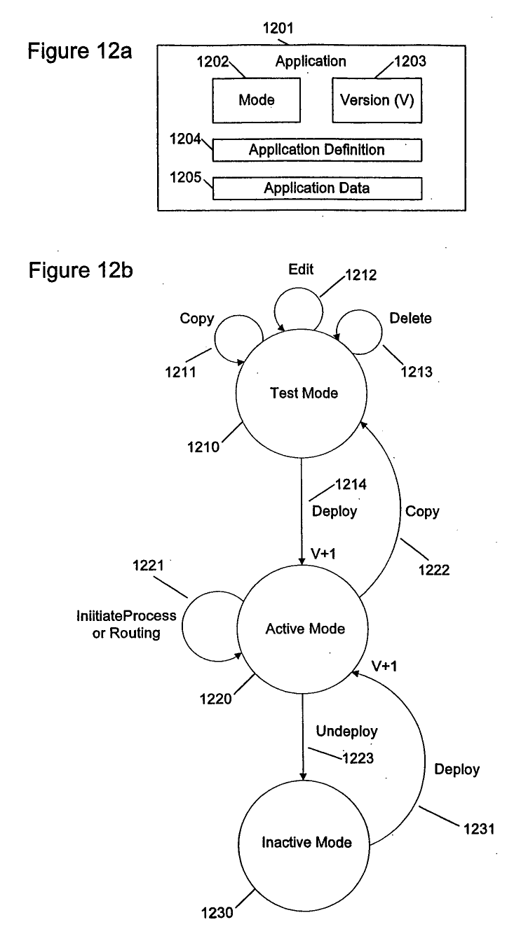

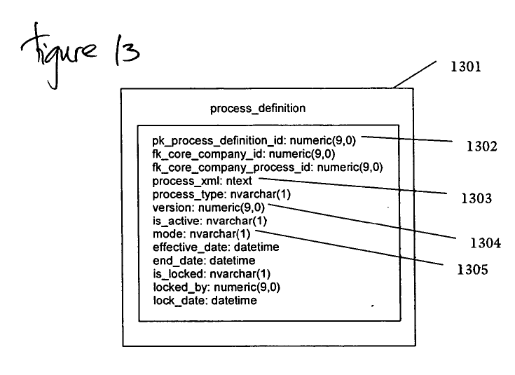

FIG. 12a is an illustrative drawing of an application 1201 including a mode 1202 and a version number 1202 according to one embodiment of the invention. The application 1201 also includes an application definition 1203 and a set of application values 1204. These values may be included in a data structure that represents the application, or may be referred to by reference from such a data structure. Once an application has been defined, it can be used as part of a complex process, e.g. a procurement process that involves multiple steps. An application can also be routed to one or more users, e.g. via email, and the users must access the application in sequence. In both cases, users run the application in the Player UI and provide input data. Since an application's definition may be loaded multiple times in these processes or routings, it is important that application definitions not be modified, e.g. by the Designer UI, while such processes or routings are in progress. To prevent applications from being modified while processes or routings are in progress, the application mode 1202 is associated with each application, and the actions that a user may perform on an application are restricted based on the mode. The mode has one of the following values: Test, Active, or Inactive.

Furthermore, when an application is modified by the Designer UI, it is possible that the modification will remove or change components of the application. Any processes or routings that use the application and are in progress at the time of modification will become invalid if the application is saved with modifications to a component used by those in-progress processes or routings. To allow users to continue to modify applications in the Designer UI while processes or routings are in progress, the version number 1203 is associated with each application, and the version number is incremented every time the application is placed in active mode as described below.

FIG. 12b is an illustrative drawing of application mode transitions according to one embedment of the invention. FIG. 12b shows three states that correspond to the three modes: a Test Mode 1210, in which the application can be modified by the Designer UI, an Active mode 1220, in which the application can be executed by the Player UI, and an Inactive mode 1230, in which the application can be neither modified nor executed. The mode of an application is displayed in a browser, e.g. as part of an Application List user interface as shown in FIG. 7g, in which the Test mode is shown in a Mode column 781 as PROD, and the Active mode is shown as PROD. As shown in FIG. 12b, only certain actions can be taken in each mode. In Test Mode 1210, it is possible to perform a Copy action 1211, an Edit action 1212, which opens a Designer UI, a Delete action 1213, and a Deploy action 1214. In Active Mode 1220, it is possible to perform an Initiate Process or Routing action 1221, a Copy action 1222, or a Deactive action 1223. In Inactive Mode 1230, it is possible to perform an Active action 1231.

The effects of each action will now be described. With reference to the Application List of FIG. 7g, a user can change the mode to one of the allowed modes by clicking a link in an Actions column 782 to perform an action such as Copy, Edit, Deploy, Undeploy, Initiate, or Delete. As shown in FIG. 12b, the Copy action 1211 creates a new application, which is a copy of an original application, except the new application is in Test Mode 1210. The Edit action 1212 opens a Designer UI for the application, and does not change the application's mode. In Test Mode 1210, the Deploy action 1214 changes the mode to Active and increments the version number. In Active Mode 1220, the Initiate Process or Routing Action 1221 initiates execution of a process or routing, which causes the application to be sent or displayed to a user in a Player UI. The Copy action 1222 changes the mode to Test Mode and creates a copy of the application. The copy can be modified by the Designer UI, but the application in active mode cannot be modified. The Undeploy action 1223 changes the mode to Inactive. The mode can be returned to Active by the Deploy action 1231, which increments the version number and sets the mode to active.

The allowed actions for an application for display in the Actions column 782 can be determined from the application's current mode as illustrated by the following pseudocode.

```
GetAllowedActions:
    If mode == Test then
      Allowed actions = (Copy, Edit, Delete, Deploy)
    Else if mode == Active then
      Allowed actions = (Initiate, Undeploy)
    Else if (mode == Inactive) then
      Allowed actions = Deploy
    End if
End of GetAllowedActions
```

When an action is selected, the mode and version number are incremented as shown by the following pseudocode:

```
HandleAction:
If mode == Test Mode then
    If action == Deploy then
        mode = Active
        version = version + 1
Else if mode == Active then
    If action == Initiate then
        Initiate process or routing
    Else if Action = Copy then
        mode = Test
    Else if Action = Undeploy then
        mode = Inactive
    End if
Else if mode == Inactive then
    If Action = Actiate then
        mode = Active
        version= version + 1
    End if
End if
End of HandleAction
```

Components can never be removed from an application, so backward compatibility is assured. Processes or routings that are executing with a version will always have access to all components of that version. There is no need to merge different versions together or lock an application definition to prevent modifications. An application definition can always be modified by creating a copy with a new version number. When a new version is created, all subsequent processes and routings will use the new version. Components can be hidden in the user interface by setting their hidden property to true, so that users will not see or interact with the components in future versions, but the components will be available for existing processes or routings that use those components. Multiple versions of an application can be active at any given time.

FIG. 13 is an illustrative drawing of a database table schema for storing an application definition according to one embedment of the invention. The tables of FIG. 14 together correspond to the application data table 124 stored in the database 110 of FIG. 1a. A process_definition schema 1301 describes the content of data in the application definition table 112 stored in the database 110 of FIG. 1a. The database 110 may be, for example, a relational database storing data records as rows in a table, where individual items in a data record are accessible as columns of a row. The process_definition schema 1301 includes a primary key column 1302 (named pk_process_definition_id), which has a unique value for each row of data in the process_definition table 1301. The process_definition schema 1301 also includes a process_xml column 1303, which stores an application definition as an XML string, a version column 1304, which stores the application version number, and a mode 1305, which stores the application mode.

FIG. 14 is an illustrative drawing of database table schemas for storing application data according to one embedment of the invention. The tables of FIG. 14 together correspond to the application data table 124 stored in the database 110 of FIG. 1a. A process_master table 1401 stores application data associated with application components and table footer rows, a process_attachment table 1410 stores attachment data associated with application components, and a process_detail table 1420 stores application data associated with table rows of table components of an application. The process_master table 1401 includes a primary key value, which uniquely identifies each row in the table. Each row in the table corresponds to a single set of data values for an application. The mapping between the application components and the tables of FIG. 14 is specified by the application definition 108 of FIG. 1a. For example, if an application has a single text box component that has a string value, then that text box component will be automatically associated with an sc1 field 1404 of the process_master table 1401, and the string value will be stored in the sc1 1404 field. If the application has two text boxes, the first text box will be associated with the sc1 1404 field, and the second text box will be associated with an sc2 field 1406. A third text box would be associated with an sc3 field 1407. Values of other types are stored similarly, but in columns with different names. For example, a numeric values for the first numeric text boxes added to an application would be stored in the nc1 field 1405. Although only three fields of each type are shown in FIG. 14, e.g. sc1 1404, sc2 1406, and sc3 1407, any number of fields could be included in the schema, e.g. 15 fields, named sc1 through sc15, to support 15 compnents with string values, and nc1-nc15 to support 15 fields with numeric values. In general, the tables of FIG. 14 include a set of fields for each type of data, including string, numeric, single character, and datetime. The Designer UI 102 of FIG. 1a, the App Designer JSP 852, and the App Player JSP 860 of FIG. 8 all use the a predefined convention for mapping components to database columns. The convention is that the components in an application definition are assigned to database fields of corresponding type in the database schema (e.g. a text box is assigned to a string field such as sc1, and a date field is assigned to a datetime field such as dtc1 of the process_master table 1401), and the components are assigned to database fields in the order that they appear in the application definition, e.g. the order that the XML elements representing the components occur in the application definition, where the database fields are ordered by the numbers appended to their names. A process_extension table 1430 stores application data for components that exceed the maximum number of components of a typeor table footer rows that can be represented in the process_master 1401 (e.g. a maximum of three string components, sc1, sc2, and sc3, can be stored in process_master table 1401), process_attachment 1410, or process_detail 1420 tables.

With reference to FIG. 1b, association of the data value 142 with a particular column of the database 144 and with the script 143 is established by the Designer UI based on minimal input from a user. When a user adds a component to an application using the Designer UI, the data type of the component's value is determined automatically based on the component. The database table in which the component's value is to be stored is also determined automatically by the Designer UI. For example, if a user adds a date component to an application, the Designer UI determines the database column to be associated with the date component. Referring to FIG. 14, that database column is the next available date column in the process_master table 1401. If the process_master table 1401 is full, e.g. the dtc1-dtc3 columns have been already been assigned to three previously-added date components, the Designer UI associates the date component with a column of the process_extension table 1430, e.g. dtc1 in the process_extension table 1430. If a user adds a date component to a table area, the Designer UI associates the date component with a corresponding column of the process_detail table 1420, based on the component type. A user can change the data type of a component. Furthermore, a user can provide values for the formatting, required, readonly, allowed characters, allowed data format, and formula component properties in the Designer UI and the Designer UI will generate the corresponding code to handle validations, formatting, and calculations.

The process_master table 1401 is related to the process_detail table 1420 by a process_master_id value, which is stored in the fk_process_master_id field 1403 of the process_master table 1401, and in the fk_process_master_id field of the process_detail table 1420. The process_master table 1401 and the process_extension table 1430 are similarly related by a process_master_id value. This process_master_id relation allows additional rows to be used for storing information about an application, e.g. additional application data values, which may be stored in the process_extension table. In particular, if an application contains more components than can be represented in the process_master table (more than 3 components of the same type, in the example of FIG. 14), then the values for components beyond the limit (e.g. beyond the third component) can be stored in the process_extension table 1420 by inserting or updating a row in the process_extension table with the same process_master_id value as the row for the component in the process_master table 1401. The values for components beyond the limit can subsequently be retrieved from the process_extension table by selecting a row that has the same process_master_id value (stored in the fk_process_master_id column of the process_extension table 1420) as the corresponding row for the component in the process_master table 1401.

The process_attachment table 1410 is related to the process_master table 1401 by a process_master_id value, which allows attachments to be stored in the process_attachment table 1410 and retrieved by selecting a row from the process_attachment table that has the same process_master_id value as a corresponding row of the process mater table 1401.

The process_detail table 1420 has a TYPE_ID column 1421 and a PARENT_ID column 1422 for representing complex, hierarchical data relationships. A unique TYPE_ID 1421 is associated with each table area. All data rows of a table area will have the same value for the TYPE_ID 1421. Different tables will have different values for the TYPE_ID 1421. The TYPE_ID 1421 is used for applications whose data relationships are of type Master-(n) Detail, i.e. a single set of components with an associated table of rows, such as most web applications of medium complexity. Each data row in the process_detail table also Parent_ID 1422, which is associated with each data row in a table area. The Parent_ID 1422 is used for applications whose data relationships are of type Master-(n) Detail-(n) Detail, i.e., a single set of components with an associated table of rows, which in turn has another table of rows. Examples of the latter type of application include Bill of Materials applications used in manufacturing and Enterprise Resource Planning systems to represent hierarchical product configurations.

Specific examples of how an application design and deployment system is used will now be described. Each example includes a set of steps to be performed by the user and the system. The examples include creating an application, saving an application, saving an application as a template, editing an application in test mode, previewing an application in design mode, initiating test routings in test mode, editing saved routings in test mode, saving a new application version in test mode, deploying an application to production mode, deactivating an application from production mode, copying an application from production mode to test mode, and deleting an application in test mode. A routing is, for example, a message that transmits an application between users, such as an email message that contains a URL link to an application.

Creating a new application involves the following steps:

CREATE NEW APPLICATION

| | |
|---|---|
| 1. | A user launches the Application Designer UI. |
| 2. | The user drags and drops components, tables, and the like from the |
| | palette to the workspace. |
| 3. | The user updates component properties, selects data types, adds |
| | formulas, and the like. |
| 4. | The system stores the new application definition in the database, |
| | updates the application mode to test, sets the version to 1, and |
| | displays the Application List screen. An application name, either |
| | provided by the user or generated by the system, is determined at |
| | or before this step and associated with the application. |

When these steps are complete, the new application screen has been saved in test mode and is available for initiating test routings and deployment to production. Creating a new application from a template involves the same steps, except step 1 includes launching the Application Designer UI with a selected template UI displayed in the workspace.

Editing an application in test mode involves the following steps:

EDIT EXISTING APPLICATION

| | |
|---|---|
| 1. | A user launches the Application Designer UI with a selected |
| | application. |
| 2. | The system loads the selected application from the database |
| | and displays the application in the Application Designer |
| | UI workspace. |
| 3. | The system locks the application definition record in the |
| | database and updates the lock columns with the user name |
| | and current time. |
| 4. | The user drags and drops components, tables, and the like |
| | from the palette to the workspace. |
| 5. | The user updates component properties, selects data types, |
| | adds formulas, and the like. |
| 6. | The user clicks save. |
| 7. | The system updates the application definition in the database, |
| | resets the lock flags, updates the application mode to test mode, |
| | and displays the Application List screen. |

When these steps are complete, the application definition has been updated and saved in test mode. The application definition is available for initiating test routings and for deployment to production mode.

Initiating test routings in test mode involves the following steps:

INITIATE TEST ROUTINGS

| | |
|---|---|
| 1. | A user launches the Application Player UI with a selected application |
| | UI displayed in the browser. |
| 2. | The system displays a Test background image to visually differentiate |
| | test routings from production routings. |
| 3. | The user updates the user interface, adds data, adds rows to tables, |
| | selects lookup data from lookup dialogs, adds attachments, and |
| | clicks save. |
| 4. | The system stores the new application data in the database. |

Editing saved routings in test mode involves the same steps listed above for initiating test routings in test mode, except that in step 2, the system also populates the existing application data in the user interface.

Deploying an application to production mode involves the following steps:

DEPLOY APPLICATION TO PRODUCTION MODE

| 1. | A user clicks the Deploy link in the Application List screen. The | |
|---|---|---|
| | Deploy Link is only shown for applications that are in test mode. | |
| 2. | The system displays a Deploy Applications dialog with the | |
| | selected application name, and sets the application's effective | |
| | date to the current date. | |
| 3. | The user clicks submit. | |
| 4. | If an existing application has been deployed to production, one | |
| | of the following two actions can be taken: | |
| | a. | Automatically deactivate the existing production application. |
| | b. | Display an alert dialog that notifies the user that the existing |
| | | application will be deactivated. The dialog can also indicate |
| | | the number of in-progress routings for this application. The |
| | | user can click OK or Cancel. Clicking |
| | | Cancel will cancel the current operation. If the user clicks OK, |
| | | then the existing application is un-deployed, i.e. made inactive. |

| | |
|---|---|
| 5. | The system creates a new application record in the database, |
| | copies the XML definition from the selected application, updates |
| | the application mode to production, sets the version number of the |
| | new application to 1 or updates the existing version number if the |
| | application has been deployed previously. |
| 6. | Finally, the system displays the Application List screen with the |
| | new application in production. |

When these steps are complete, a new application definition has been created with a new version number and saved in production mode. The effective date of the application is set to the current date or whatever date the user specifies in the deployment dialog.

An application may be deactivated, for example, when an application administrator wants to un-deploy a production application to make modifications to the application. Deactivating from production mode involves the following steps:

DEACTIVATE FROM PRODUCTION

| | |
|---|---|
| 1. | A user clicks the UnDeploy link in the Application List screen. The |
| | UnDeploy Link is only shown for applications that are active and in |
| | production mode. Only one version of an application can be active |
| | and in production at any given point in time. |
| 2. | The system displays an UnDeploy Applications dialog with the |
| | selected application name. |
| 3. | The user clicks submit. |
| 4. | The system updates the record in the database by marking the |
| | selected definition as inactive. |
| 5. | Finally, the system displays the Application List screen. |

When these steps are complete, the selected production application is inactivated.

Copying an application from production mode involves the following steps:

COPY APPLICATION FROM PRODUCTION TO TEST MODE

| | |
|---|---|
| 1. | A user clicks the Copy link in the Application List screen. |
| 2. | The system creates a new application record in the database, |
| | copies the XML definition from the selected application, |
| | updates the application mode to “test”, and sets the version |
| | number of the new application to max(test_version_number) + 1. |
| | The system also sets the “Copy from Production” flag to Y. When |
| | this flag is set to Y, existing controls cannot be deleted from the |
| | application; instead, they can be hidden from the UI. |
| 3. | Finally, the system displays the Application List screen with |
| | the new application in test. |

When these steps are complete, a new application definition has been created with a new version number and saved in test mode.

Copying from an application in test mode involves the following steps:

COPY APPLICATION IN TEST MODE

| | |
|---|---|
| 1. | A user clicks the Copy link in the Application List screen. |
| 2. | The system creates a new application record in the database, |
| | copies the XML definition from the selected application, |
| | updates the application mode to “test”, and sets the version |
| | number of the new application to max(test_version_number) + 1. |
| 3. | The user clicks the Edit link in the Application List screen. |
| 4. | The App Designer UI is displayed with the selected application. |
| | The user can add new controls, including fields, tables, and the |
| | like, and can delete existing controls and tables from the UI. |

When these steps are complete, a new application definition has been created with a new version number and saved in test mode.

Deleting an application in test mode is accomplished by setting a delete indicator for the application's definition in the database and hiding the definition from the UI. All test routings based on the definition will still work with the existing definition.

Initiating routings in production is accomplished by initializing the Player UI with the latest application version in production that is marked as active. Previous versions of the application are only used for in-progress routings.

The Application Designer and Player meet the need for an easy-to-use tool for developing Web-based data processing applications that allow for data input, validation, processing, and linkage with Web services, and enable the creation of applications by the non-technical user community. Since the Designer and Player are Web-based, they can be used by any user who is familiar with a web browser. The Designer's user interface allows a user to create Web-based applications that include forms for accepting data input. A web application's user interface can be defined in terms of a user interface and data values. Linkage between the data values, a database, and scripts are determined by the Designer based on minimal input from a user.

The Designer's action builder adds processing in scripting language, the link builder adds input and output of data from and to external sources, and the Web Services builder adds interaction with Web Services. The combination of these features provides a comprehensive, easy-to-use, application development tool.

The above description is exemplary only and it will be apparent to those of ordinary skill in the art that numerous modifications and variations are possible. For example, various exemplary methods and systems described herein may be used alone or in combination with various other computer and computer peripheral systems and methods. Additionally, particular examples have been discussed and how these examples are thought to address certain disadvantages in related art. This discussion is not meant, however, to restrict the various examples to methods and/or systems that actually address or solve the disadvantages.

1. A computer enabled method of creating a software application, comprising the acts of:
providing a user interface for designing the software application on a web browser;
defining aspects of the application via the web browser using the user interface; and
transmitting the defined aspects to a server over a computer network thereby to create a web-based software application.

2. The method of claim 1, further comprising the acts of:
providing a plurality of components on the web browser; and
implementing some of the aspects of the application using the components.

3. The method of claim 1, further comprising the acts of:
providing a library on the browser; and
using the library as an intermediary between the defined aspects at the browser and the server.

4. The method of claim 1, wherein the computer network includes the Internet.

5. The method of claim 1, further comprising, at the server, the acts of:
rendering a representation of the application from the transmitted defined aspects;
retrieving data associated with the application from a storage; and
transmitting the representation and retrieved data to a client.

6. The method of claim 5, further comprising, at the server, the acts of:
tracking a plurality of versions of the software application;
maintaining each version as compatible with prior versions of the software application; and
allowing a plurality of the versions to be active at the same time.

7. The method of claim 5, further comprising, at the client, the act of:
executing the representation and data on a web browser.

8. The method of claim 7, further comprising the acts of:
providing a library on the web browser of the client; and
using the library as an intermediary between the web browser of the client and the server.

9. A computer enabled method of providing a software application, comprising the acts of:
receiving at a server over a computer network from a first client web browser a software application including defined aspects of the application;
rendering a representation of the application from the received defined aspects;
retrieving data associated with the application from a storage; and
transmitting the representation and retrieved data to a second client.

10. The method of claim 9, further comprising the acts of:
providing a user interface on the web browser at the first client for designing the software application;
defining the aspects of the application using the user interface; and
transmitting the defined aspects to the server over the computer network.

11. The method of claim 9, further comprising the acts of:
tracking a plurality of versions of the software application;
maintaining each version as compatible with prior versions of the software application; and
allowing a plurality of the versions to be active at the same time.

12. The method of claim 9, wherein the computer network includes the Internet.

13. The method of claim 10, further comprising, at the second client, the acts of:
providing a web browser; and
providing a user interface to a user on the web browser from the received representation and data.

14. The method of claim 13, further comprising, at the second client, the acts of:
providing a library on the browser; and
using the library as an intermediary between the browser and the server.

15. A computer enabled method of providing a software application, comprising the acts of:
receiving over a computer network aspects of an application from a server;
executing the application on a web browser;
providing a user interface; and
allowing use of the application via the user interface.

16. A client to be executed on a computer, comprising:
a user interface adapted for designing a software application on a web browser; and
an application definition module which defines aspects of the software application via the web browser using the user interface;
wherein the web browser transmits the defined aspects to a server over a computer network thereby to create the software application.

17. The client of claim 16, wherein a plurality of components are on the web browser; and
some of the aspects of the application are implemented using the components.

18. The client of claim 16, further comprising
a library on the browser, wherein
the library being used as an intermediary between the defined aspects at the browser and the server.

19. The client of claim 16, wherein the computer network includes the Internet.

20. An application server to be executed on a computer, comprising:
an application definition module for receiving over a computer network from a first client web browser a software application including defined aspects of the application and rendering a representation of the application from the received defined aspects;
a service for retrieving data associated with the application from a storage; and
an application player module for transmitting the representation and retrieved data to a second client.

21. The server of claim 20, further comprising:
a version control for tracking a plurality of versions of the software application, maintaining each version as compatible with prior versions of the software application, and allowing a plurality of the versions to be active at the same time.

22. A player client to be executed on a computer, comprising:
a definition module for receiving over a computer network aspects of an application from a server;
a data module for receiving over the computer network from the server data relating to the application; and
a user interface for executing the application on a web browser.

23. The client of claim 22, further comprising using a library on the browser as an intermediary between defined aspects of the application and the server.

24. A method of running an application program in a web browser, comprising the acts of:
providing at least one client computer and one server computer in communication with the network,
executing a web browser on the client computer;
executing a client portion of the application program on the web browser, wherein the client portion presents a runtime user interface according to an application definition, the application definition includes a component described by a component definition, the component includes a name and a data value, and the client portion receives the data value from a user; and
executing a server portion of the application program on the server computer, wherein the server portion receives the data value from the client portion and stores the data value in a database, as specified by the application definition.

25. The method of claim 24, wherein the component further includes a link, the link refers to a web service, and the client program receives the data value from the web service in response to a user action.

26. The method of claim 24, wherein the component further includes a script operable to execute in response to an application event, the script further operable to perform calculations based on a data value associated with another component.

27. The method of claim 24, wherein the component further includes a script operable to execute in response to an application event, the script further operable to set a data value associated with another component.

28. The method of claim 24, wherein the component is associated with a row of a table component.

29. A method of designing an application program in a web browser, comprising the acts of:
providing at least one client computer and one server computer in communication with the network,
executing a web browser on the client computer;
executing a designer program on the web browser, wherein the designer program presents a user interface that includes a workspace upon which a user can place an interface component at a specified location, the interface component being associated with a component data value, and the designer program creates an application definition, the application definition describing properties of the interface component, the application definition including an association between the component data value and a corresponding column of a table in a database.

30. The method of claim 29, wherein the component is associated with a link, the designer program receives from a user a Uniform Resource Locator associated with the link and the program adds the link to the application definition in association with the interface component.

31. The method of claim 29, wherein the component is associated with a computer program code script, the designer program receives from a user the computer program code script, the computer program code script is operable to perform calculations based on the value of another component, and the designer program adds the computer program code script to the application definition in association with the interface component.

32. The method of claim 29, wherein the computer program code script is operable to set the value of another component.

33. The method of claim 29, wherein the user can further place a table component upon the workspace, the table component comprising:
a table header row, comprising at least one column definition; and
a table detail row, comprising at least one column corresponding to the at least one column definition, wherein the at least one column is associated with at least one detail component having a detail data value; wherein
the application definition describes the table component and an association between the at least one detail data value and a corresponding detail column in a database.
